(19) United States
(12) Patent Application Publication
(10) Pub. No.: US 2010/0152900 A1
(43) Pub. Date: Jun. 17, 2010

(54) Optimizing refinery hydrogen gas supply, distribution and consumption in real time

(75) Inventors: Chris S. Gurciullo, Nokesville, VA (US); Marco A. Andrei, Fairfax, VA (US); Dave W. Barrett-Payton, Winchester (GB); Apostolos T. Georgiou, Reston, VA (US)

Correspondence Address: ExxonMobil Research and Engineering Company, P.O. Box 900, Annandale, NJ, 08801-0900, US

(73) Assignee: ExxonMobil Research and Engineering Company, Annandale, VA (US)

(21) Appl. No.: 12/587,509

(22) Filed: Oct. 8, 2009

Related U.S. Application Data
(60) Provisional application No. 61/136,873, filed on Oct. 10, 2008.

(51) Int. Cl. G05B 21/00

(52) U.S. Cl. 700/272

(57) ABSTRACT

The present invention is directed to innovative and unique mathematical models that capture key constraints, process kinetics and control structures such that a wide envelope of hydrogen gas and associated light gas supply, distribution and use can be modeled. The present invention is also directed to a real time optimization (RTO) computer application for effective optimization of hydrogen and associated light gas supply and distribution and, thereby, consumption, in a refinery that employs said models and solves an objective function, as well as to a method and refinery using the same. The objective function can be an economic objective function such as the minimization of cost for hydrogen supply and distribution or the maximization of profit based on a valuation of products made by hydrogen consumers in the hydrogen system minus the corresponding cost of the hydrogen supply and distribution.

### CROSS REFERENCE TO RELATED APPLICATIONS

This application relates to and claims priority to U.S. Provisional Patent Application No. 61/136,873, entitled “Optimizing Refinery Hydrogen Gas Supply, Distribution and Consumption in Real Time,” filed on Oct. 10, 2008.

### BACKGROUND OF THE INVENTION

1. Field

The present invention is directed to optimization of hydrogen gas supply (e.g., acquisition) and use in a refinery to achieve an objective function. More particularly, the present invention is directed to mathematical models that capture key constraints, process kinetics and control structures such that a wide envelope of hydrogen gas and associated light gas use can be modeled, as well as a real time optimization (RTO) employing said models, a method of optimizing the supply and allocation of hydrogen gas in a refinery using said RTO and a refining operation containing said RTO.

2. Description of Related Art

Refineries, especially oil refineries, often comprise numerous hydroprocessing reactors that consume hydrogen at individual rates, purities and pressures. The hydrogen to run these hydroprocessing reactors is obtained from a variety of sources, each of which provides hydrogen at individual rates, purities, pressures and costs. A complex array of piping distributes the hydrogen gas from the various supply sources to the various consumption sites. Integrated into this complex array of piping are controls that alter, among other things, the flow rate, purity and/or pressure of hydrogen.

Modern integrated oil refineries are being pressed to conform to increasingly tighter manufacturing constraints and specifications. For example, the permissible sulfur content for diesel fuel has decreased from 500 ppm to 10 ppm. In addition, the rising price and the lower availability of high quality crude oil is causing oil refineries to select lower quality feed stocks. These factors produce an environment where the role of hydrogen consuming operations is of growing importance and where the cost and availability of hydrogen for these operations is business critical. Industry has been successful in developing mathematical model based computer applications that optimize the performance and profitability of individual refinery units. However, to date, industry has been unsuccessful in developing a mathematical model based computer application that can optimize the complex hydrogen network across an entire refinery in order to control total hydrogen supply and distribution and, thereby, consumption.

### BRIEF DESCRIPTION OF THE DRAWINGS

The drawings are provided for illustrative purposes only. The drawings are not intended to limit the scope of the present teachings in any way.

FIG. 1 is a flow diagram showing the movement of light gases through an illustrative refinery.

FIG. 2 is a flow diagram showing the movement of light gases and oil products through an illustrative hydrotreating unit.

FIG. 3 shows the order of reactors and reactions in an illustrative H₂ plant.

FIG. 4 shows the movement of H₂ gas through an illustrative H₂ gas manifold.

FIG. 5 shows the flow of feed into and the flow of permeate and retentate out from an illustrative H₂ separation membrane.

FIG. 6 is an illustrative graph of a variable penalty function.

FIG. 7 outlines a method of the invention.

### SUMMARY OF THE INVENTION

Small improvements in the cost of hydrogen gas acquisition, or in the reduction of “waste” through excess consumption or loss to fuel gas, can have substantial impact on refinery profits. The present invention is able to capture such improvements.

One embodiment of the invention is a system wide model (H₂ system model) for characterizing a hydrogen supply, distribution and consumption system (hydrogen system) in a refinery, such as an oil refinery. The hydrogen system might be for only a particular window of operations, but preferably the hydrogen system is for the entire refinery and includes all the hydrogen gas producers and hydrogen gas consumers in the refinery, as well as the headers and controls used to deliver the hydrogen and associated light gases from the producers to the consumers. The hydrogen system comprises one or more, and preferably multiple, supply sources that provide hydrogen at individual rates, purities, pressures and costs, multiple consumption sites that consume hydrogen at individual rates, purities and pressures and an interconnecting hydrogen distribution network. The H₂ system model is a collection of non-linear kinetic models of the individual components in the hydrogen system impacting the movement and consumption of hydrogen. In some cases, non-linear kinetic models for components in the hydrogen system that impact the supply of hydrogen are also included (e.g., if an H₂ plant exists in the refinery). The H₂ system model tracks hydrogen gas, and preferably also tracks associated light gases including C₁-C₅ hydrocarbons, H₂, H₂O, CO, CO₂, H₂S, and NH₃, given operational conditions. The H₂ system model represents each molecule type in a light gas stream as a discrete component. Preferably, the H₂ system model also tracks the disposal of unused or expended hydrogen gas and associated light gases into the fuel gas system (i.e., the furnaces) used to power the refinery.

Another embodiment of the invention is an apparatus comprising a RTO computer application for a hydrogen system (H₂ system RTO) in a refinery, preferably an oil refinery. The RTO application is stored on a program storage device readable by a computer. The H₂ system RTO monitors and optimizes the supply (e.g., acquisition) and allocation and, thereby, consumption, of hydrogen gas in the hydrogen system. Preferably, the hydrogen system is as previously described and, therefore, comprises one or more, and preferably multiple, supply sources that provide hydrogen at individual rates, purities, pressures and costs, multiple consumption sites that consume hydrogen at individual rates, purities and pressures and an interconnecting hydrogen distribution network. The H₂ system RTO contains an H₂ system model. Preferably, the H₂ system model is as previously described and, therefore, comprises linked, non-linear, kinetic models that characterize the movement and consumption (and in some cases the supply if, for example, an H₂ plant exists) of hydrogen gas in the hydrogen system. The H₂ system RTO loads current operating data and uses said operating data to populate and calibrate the models. The H₂ system RTO also loads operating constraints for the hydrogen system. The H₂ system RTO then manipulates, in an iterative manner, model variables to determine feasible solutions of operating targets for the hydrogen system that meet operating constraints. Finally, the H₂ system RTO outputs a recommended solution of operating targets that will move the operation of the hydrogen system toward a performance related objective function. Preferably, the recommended solution is the optimal solution to the objective function. The H₂ system RTO is loaded and runs on a conventional Windows/Unix/VMS based server or desktop computer.

Yet another embodiment of the invention is a method of controlling the supply (e.g., acquisition) and allocation and, thereby, consumption, of hydrogen gas in a hydrogen system of a refinery, preferably an oil refinery. Preferably, the hydrogen system is as previously described and, therefore, comprises one or more, and preferably multiple, supply sources that provide hydrogen at individual rates, purities, pressures and costs, multiple consumption sites that consume hydrogen at individual rates, purities and pressures and an interconnecting hydrogen distribution network. The method comprises at least five computer implemented steps. The first-step is activating a H₂ system RTO application. Preferably, the H₂ system RTO application is as previously described and, therefore, comprises linked non-linear kinetic models that characterize the movement and consumption (and in some cases the supply if, for example, an H₂ plant exists) of hydrogen gas in the hydrogen system. The second step is loading current refinery operating data into the application and using said operating data to populate and calibrate the models. The third step is manipulating, in an iterative manner, model variables to determine feasible solutions of operating targets for the hydrogen system that meet operating constraints. The fourth step is determining a recommended solution of operating targets that moves the hydrogen system toward a performance related objective function. The fifth step is implementing the recommended solution of operating targets using at least one process control system. Preferably, the recommended solution is the optimal solution to the objective function. However, it may also be a near optimal solution.

Finally, another embodiment of the invention is a refinery, preferably an oil refinery. The refinery comprises at least three components. The first component is a hydrogen system. Preferably, the hydrogen system is as previously described and, therefore, comprises one or more, and preferably multiple, supply sources that provide hydrogen at individual rates, purities, pressures and costs, multiple consumption sites that consume hydrogen at individual rates, purities and pressures and an interconnecting hydrogen distribution network. The second component is at least one process control system that controls the hydrogen system. The third component is a H₂ system RTO application for optimizing the supply and allocation and, thereby, consumption, of hydrogen gas in the hydrogen system. Preferably, the H₂ system RTO application is as previously described and, therefore, comprises linked non-linear kinetic models that characterize the movement and consumption (and in some cases the supply if, for example, an H₂ plant exists) of hydrogen gas in the hydrogen system. The H₂ system RTO loads current operating data and uses said operating data to populate and calibrate the models. The H₂ system RTO also loads operating constraints for the hydrogen system. The H₂ system RTO then manipulates, in an iterative manner, model variables to determine feasible solutions of operating targets for the hydrogen system that meet operating constraints. The H₂ system RTO then outputs a recommended solution of operating targets to move the operation of the hydrogen system toward a performance related objective function. Finally, the H₂ system RTO communicates the recommended solution of operating targets to the process control system. Preferably, the recommended solution is the optimal solution to the objective function.

These and other features of the invention are set forth in more detail below.

### DETAILED DESCRIPTION OF THE INVENTION

### Definitions

Unless expressly defined otherwise, all technical and scientific terms used herein have the meaning commonly understood by those of ordinary skill in the art. The following words and phrases have the following meanings:

“Light gas” means any gaseous or semi-gaseous molecule with a molecular weight that is less than or equal to pentane (i.e., less than or equal to 75). Typical light gases in a refinery include C₁-C₅ hydrocarbons such as methane (C₁H₄), ethane (C₂H₆), propane (C₃H₈), butane (C₄H₁₀) and pentane (C₅H₁₂), as well as hydrogen (H₂), nitrogen (N₂), water (H₂O), carbon monoxide (CO), carbon dioxide (CO₂), hydrogen sulfide (H₂S) and ammonia (NH₃).

“Model” embraces a single model or a construct of multiple component models.

“Operating target” means a set point for a control variable (e.g., a temperature, pressure, flow rate, gas purity, valve position or compressor speed).

“Real time,” as used herein, is relative to the speed of process transients in a hydrogen supply, distribution and consumption system. Real time means at a speed equal to or faster than the response time necessary for the hydrogen system to reach a steady state when one or more of its operating variables has changed. Thus real time is typically a matter of minutes if not seconds.

“Real time optimization” or “RTO” means a model based computer program that performs a full optimization cycle (data collection, reconciliation and optimization) in real time on a conventional Windows/Unix/VMS based server or desktop computer.

“Supply” in the context of hydrogen supply to a refinery embraces, but is not limited to, the flow of hydrogen into the refinery from a non-refinery source (whether free or purchased) and hydrogen manufactured by the refinery.

“On-line” means in communication with a process control system. For example, refinery model variables tuned on-line are typically tuned automatically with refinery data pulled from a refinery process control system. In contrast, refinery model variables tuned off-line are typically tuned with manually input data from other sources (e.g., a plant data historian and/or laboratory data).

### The Operations Modeled

One embodiment of the invention is a collection of non-linear kinetic models for individual components in a hydrogen supply, distribution and consumption system (hydrogen system) of a refinery, such as an oil refinery, that are linked by a logic flow sheet to create an overall model (H₂ system model) and track the distribution and consumption, and in some cases supply, of hydrogen gas. Preferably, the H₂ system model also tracks the movement and supply of associated light gas molecules (e.g., C₁-C₅ hydrocarbons, H₂, H₂O, CO, CO₂, H₂S, and NH₃). The H₂ system model represents each molecule type in a light gas stream as discrete components. Ideally, the H₂ system model tracks the disposal of unused or expended hydrogen and associated light gases into the fuel gas system (i.e., the furnaces) used to power the refinery.

In an oil refinery, the window of refinery operations modeled would typically include one or more hydrotreating units that remove contaminants such as sulfur (i.e., hydrodesulfurization) and nitrogen (i.e., hydrodenitrogenation) from hydrocarbon streams and/or cause saturation (i.e., hydrogenation) of hydrocarbon streams by a catalytic process performed in the presence of hydrogen. Each hydrotreating unit consumes hydrogen at an individual rate, purity and pressure, to produce a variety of products having set specification requirements and, to a varying degree, recycles unexpended hydrogen. Therefore, each hydrotreating unit should be independently modeled.

In an oil refinery, the window of refinery operations modeled would also typically include one or more hydrocracking units that convert heavy complex organic molecules into relatively lighter saturated hydrocarbons by a catalytic process performed in the presence of hydrogen. Each hydrocracking unit consumes hydrogen at an individual rate, purity and pressure, to produce a variety of products having set specification requirements and, to a varying degree, recycles unexpended hydrogen. Therefore, each hydrocracking unit should be independently modeled.

Preferably, the hydrogen used by the hydroprocessing reactors (i.e., the hydrotreaters and hydrocrackers) comes from a variety of supply sources, each of which provides hydrogen at an individual rate, purity, pressure and cost. One common source of hydrogen in an oil refinery is a catalytic reformer. Catalytic reformer units chemically rearrange hydrocarbon molecules to produce higher octane reformate and, in the process, generate a light gas by-product. Light gas from a catalytic reformer column typically contains a high ratio of H₂ to light hydrocarbons. This light end stream is then de-ethanized/depropanized to get a high concentration H₂ stream. However, in many cases the reformer cannot satisfy all of the H₂ requirements of the refinery. This is often true, for example, where one or more hydrocrackers are in operation. In such cases, additional H₂ can be purchased on the open market or pumped in from an associated petrochemical plant or some other source. Additional hydrogen gas can also be produced in an H₂ plant where a hydrocarbon feed (typically C₁ through C₆ hydrocarbons) is converted to H₂ and CO₂.

An important decision in the modeling process is whether a given hydrogen supplier should be optimized. If optimizing a hydrogen supplier is not possible or not desired, then the hydrogen product from the producer can be treated as a fixed source of constant flow and composition and a model of the hydrogen supplier is not required. For example, hydrogen gas purchased on the open market or pumped in from a source outside the refinery is typically not under the direct control of the refinery but is available at a known rate, purity and cost on a constant basis (or on demand within a limited operating window). Since there is no possibility of detailed optimization or control, there is no need to model such supply sources. Further, if a hydrogen supplier unit's overall business objective is significant, and altering the unit's operation to adjust hydrogen levels is inconsistent with that business objective, then an optimization on that unit is not desirable and no model is needed. This is typically the case for catalytic reformers since making motor gasoline is significantly profitable and, therefore, changing a reformer's operation to improve hydrogen usage but reduce motor gasoline is not desirable. In all of these cases, the minimum and maximum H₂ that must be utilized or that is available (e.g., under contract terms) from each of the sources, and the cost and composition of the same, can be characterized in the H₂ system model as an operating constraint by direct data input.

However, in many cases it is desirable to include some supplier optimization within the scope of the process simulation. For example, the operation of an H₂ plant typically should be modeled, since the sole purpose of an H₂ plant is to provide hydrogen gas for network use and the operation of an H₂ plant is typically under the complete control of the refinery.

An array of complex piping and controls distributes the hydrogen gas from the various hydrogen supply sources to the various hydrogen consumption sites. Integrated into this array of piping are controls that alter the flow, rate, purity and/or pressure of the hydrogen gas. These controls may include, inter alia, valves, compressors, separation membranes, scrubbers (which typically attract CO₂ and other contaminants into solution) and pressure swing absorber (“PSA”) devices (which typically employ a catalyst to absorb CO, CO₂, and other contaminants). The hydrogen gas manifold and each of these control points should be modeled.

In addition, it is preferable to include some modeling of the refinery fuel gas system as part of the H₂ system model since in most cases this is the ultimate destination of the spent light gases. These models would represent the operation of the release valves thereto and the different furnace requirements.

Thus, a typical H₂ system model might characterize one or more, and preferably multiple, supply sources that provide hydrogen at individual rates, purities, pressures and costs, multiple consumption sites that consume hydrogen at individual rates, purities and pressures and an interconnecting hydrogen distribution network. Preferably, for an oil refinery, the supply sources comprise multiple sources selected from purchased hydrogen, on-site hydrogen manufacturing plants, hydrogen rich off gases recycled from hydrogen consumption sites, hydrogen rich off gases produced by a catalytic reformer and hydrogen routed from an associated petrochemical plant. Preferably, the consumption sites comprise multiple hydroprocessing units selected from hydrotreaters and hydrocrackers. Preferably, the interconnecting hydrogen distribution network comprises multiple control components to alter the flow, rate, purity and/or pressure of hydrogen selected from the group consisting of valves, separation membranes, scrubbers, pressure swing absorbers and compressors. Preferably, the H₂ system model also embraces the disposal of unused or expended hydrogen and associated light gas into the fuel gas systems that power the refinery. In one particularly preferred embodiment, the H₂ system model comprises a collection of linked models for each of the following: (1) catalytic hydroprocessing units (e.g., hydrotreaters, hydrocrackers, etc.); (2) reactor operations in hydrogen manufacturing plants (e.g., operations in the steam reformer, the water shift units and methanator); (3) the manifold header for H₂ gas distribution; (3) separation/purification operations (e.g., PSA devices, membranes, CO₂ scrubbers, etc.); (5) valves in the distribution system, reactor units and release valves to the fuel gas system (including valve opening constraints); (6) compressors in the distribution system and reactor units (including compressor performance curves); and (7) fuel gas furnace requirements.

Typically, the highest purity hydrogen gas is first fed to the most critical/highest severity hydroprocessing unit(s) which consume some, but not all, of the hydrogen. The resulting off-gas from these units is lower in hydrogen purity. The off-gas is then collected (generally with some amount of separation, scrubbing, etc.) and recycled in the unit or used to feed other hydroprocessing unit(s). At various points, the hydrogen purity of these streams becomes very low and the streams are then utilized as fuel gas, hydrogen plant feed, or sent through a purification process. The cascade of hydrogen through the various units and other processes often involves a large portion of the refinery.

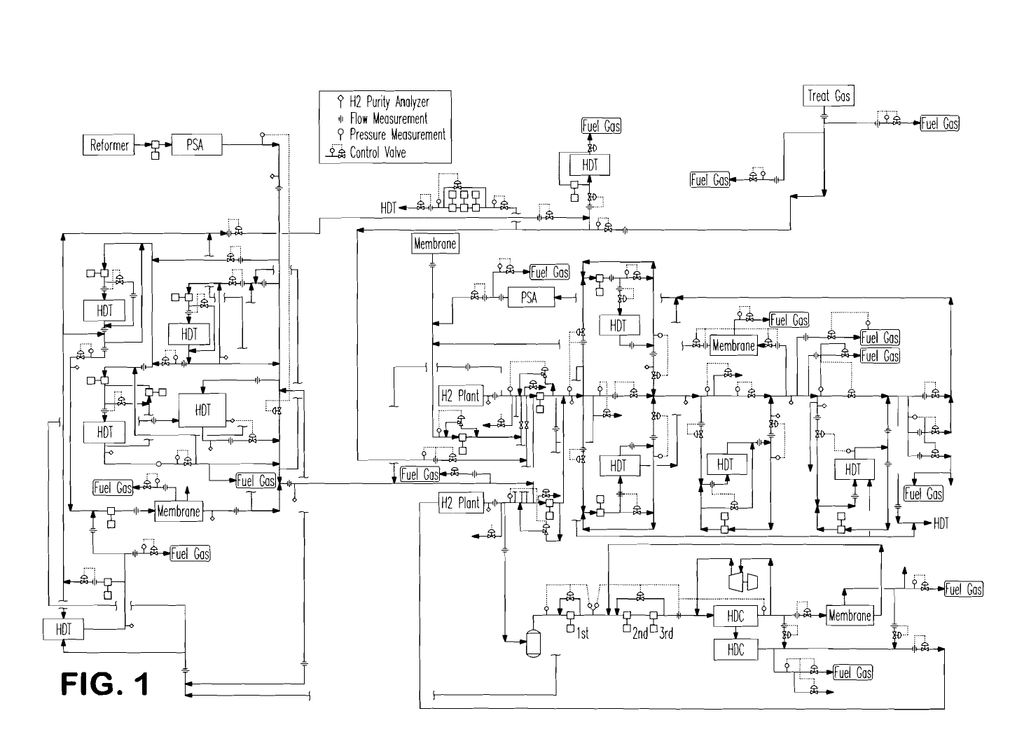

To illustrate, FIG. 1 is a flow diagram showing the movement of light gases through a representative refinery. For the sake of simplification, the flow diagram only shows the movement of hydrogen and associated light gases. The movement of heavier streams (e.g., the primary unit feeds and products) is not shown. In FIG. 1, there are numerous hydrotreater (HDT) units for treating a variety of petroleum derived products. These products might include gasoline, naptha, kerosene, jet fuel, diesel and other product streams from a distillation tower. There are also hydrocracking units (HDC) for treating heavy streams from a variety of sources including, typically, gas oil from an atmospheric distillation tower and residues from a vacuum distillation unit. These are the hydrogen consumers. Also shown in FIG. 1 are a catalytic reformer (Reformer) unit and an H₂ plant (H2 Plant). These are hydrogen sources. Purchased hydrogen is another hydrogen source. Also shown in FIG. 1, connecting the hydrogen consumers and hydrogen sources is a complex web of piping and membranes, PSA and valve operations for controlling the flow and composition of the light gas streams. As shown in FIG. 1, pressure, temperature, and flow rate information for this distribution system is readily available from on-line analyzers at multiple points in the process. This analyzer information is generally fed into a process control system. Finally, FIG. 1 shows multiple sites where the hydrogen and other light gases are dumped into the fuel gas system and burned in the furnaces that power the refinery.

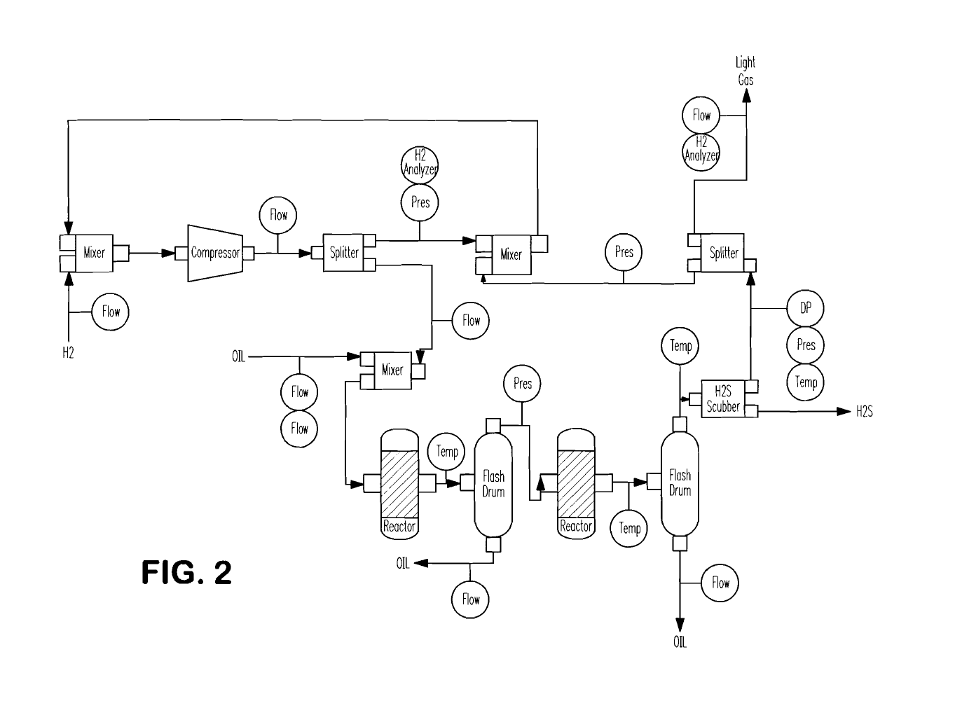

FIG. 2 is a flow diagram showing the movement of oil derivatives (“Oil”) and light gases including hydrogen gas through a hydrotreating unit. The flow diagram in FIG. 2 is illustrative of the hydrotreating units shown in FIG. 1.

As evident from FIG. 1 and FIG. 2, the piping and controls for moving hydrogen and associated light gases between supply and consumption units, and within supply and consumption units, are quite complex. An effective H₂ system model must characterize the operation of each of the major hydrogen sources, sinks, and distribution and manipulation operations in the envelope of refinery operations selected.

### Model Construction

For a given window of refinery operations, and preferably, for an entire refinery, individual components in the hydrogen supply, distribution and consumption system are modeled. These component models, or submodels, are then connected in a flow sheet to form an overall H₂ system model that represents the flow distribution of hydrogen and light gas through most, and preferably all, of the refinery.

Preferably, all of the submodels are constructed using open form, non-linear equation-based modeling software and methods that support the use of multiple solution modes with multiple objective functions (e.g., data reconciliation which adjusts variables based on actual plant data and an economic optimization mode). Suitable examples of commercially available software and methods include DMO which is a modeling platform available from Aspen Technology, Inc. and ROMeo® (Rigorous On-line Modeling with equation-based optimization) which is a modeling platform available from Invensys SimSci-Esscor. Preferably, the system model is constructed using ROMeo models and methods. These systems already have code based on underlying equations which are suitable, or may easily be configured by one of ordinary skill in the art to be suitable, for modeling many of the hydrogen system components (e.g., valves, compressors, scrubbers etc. . . . ). However, for the more complex components of a hydrogen system (e.g., the hydroprocessing reactors, hydrogen plant reactors, H₂ plant, gas manifold and membrane units), models have to be custom built because suitable code and underlying equations for tracking the hydrogen and associated light gas movement through the component units does not already exist.

Typically, instead of tracking the composition of each feed stream, product stream and by-product molecular species through the unit, the custom submodels for the more complex units are simplified using creative lumping.

This greatly increases computation speed. Otherwise, the H₂ system model tends to become so complex that it is not computationally manageable.

More particularly, the submodels for the more complex units are customized to focus on capturing the behavior of the light gases only. In other words, the light gases are represented as discrete components and the kinetic models are developed in a fashion that focuses on accurately describing the impact of the process changes on the light gases. For instance, most species with a carbon number lower than six are represented in the model as individual components. In contrast, higher carbon number components are lumped together in groups based on distillation range to reduce computational difficulty.

The preferred process for designing models for the different components in the hydrogen system is described in more detail below:

### Modeling Hydrotreating Reactors

Hydrotreating reactions are conversion reactions that occur in the presence of hydrogen. There are four main hydrotreating reaction mechanisms, namely: (1) desulphurization, where organic sulfur compounds in the predominantly hydrocarbon feed react with hydrogen inside the reactor to produce hydrogen disulfide and paraffins; (2) denitrogenation, where organic nitrogen compounds in the predominantly hydrocarbon feed react with hydrogen inside the reactor to produce ammonia and paraffins; (3) saturation/hydrogenation of olefin, diolefin and other unsaturated non-aromatic compounds (collectively, “olefinic compounds”), where the olefinic compounds in the predominately hydrocarbon feed undergo addition reactions with hydrogen inside the reactor to produce paraffins; and (4) saturation/hydrogenation of aromatic compounds, where aromatic compounds in the predominately hydrocarbon feed undergo addition reactions with hydrogen inside the reactor to produce paraffins. All four of these reaction mechanisms occur simultaneously inside each hydrotreating reactor and should be represented in the model.

The hydrotreating reactor models are rigorous custom models that utilize Arhenius type equations to calculate the hydrogen consumption needs of each hydrotreating unit represented. The hydrotreating kinetic models are customized in a fashion that focuses on accurately describing process changes on light gases only. For each hydrotreating unit, the rate of hydrogen consumption required to perform the reaction mechanisms described above is a function of key properties of the reactor and the feed to the reactor. The key reactor properties include reactor operating temperature, pressure and residence time. The key feed properties include light gas phase species (i.e., H₂, H₂S and NH₃) which are important in order to capture inhibition effects.

The formula for determining the actual rate of hydrogen consumption by a given hydrotreating reactor due to a given reaction mechanism can be generically expressed as follows:

ν_{HT,i}={K1ᵢ*Pres*e^{(-Ea}^{ᵢ}^{/Temp)/LHSV*[H}₂]/(K2ᵢ*[H₂S]+K3ᵢ*[NH₃]+1.0)}*[Xᵢ],

where “ν_{HT,i}” is the actual rate of hydrogen consumption in a given reactor due to a given hydrotreating reaction mechanism “i,” where “K1ᵢ” is an arbitrary rate constant that represents the overall activity of hydrotreating reaction “i’ in the reactor tuned online to match hourly changes in plant operation, where “Pres” is the pressure in the reactor, where “Eaᵢ” is the activation energy for hydrotreating reaction “i” tuned off line to match plant test data (i.e., tuned manually when additional data from lab analysis is available), where Temp” is the temperature of the reactor, where “LHSV” is the liquid hourly space velocity or residence time of feed in the reactor, where “[H₂]” is the mole fraction of hydrogen gas in the reactor as measured by analyzing product from the reactor, where “K2ᵢ” is an inhibition factor for hydrotreating reaction “i” due to the presence of H₂S in the reactor and, like the activation energy, is tuned off line to match plant test data (a higher K2ᵢ means more inhibition), where “[H₂S]” is the mole fraction of H₂S in the reactor as measured by analyzing product from the reactor, where “K3ᵢ” is an inhibition factor for hydrotreating reaction “i” in the reactor due to the presence of NH₃ and, like the activation energy, is tuned off line to match plant test data (a higher K3ᵢ means more inhibition), where “[NH₃]” is the mole fraction of ammonia in the reactor as evidenced by analyzing product from the reactor, and where “[Xᵢ]” is the mole fraction of reactants for hydrotreating reaction “i” present in the reactor as evidenced by analyzing product from the reactor. As evident, this is a continuous stirred tank reactor (CSTR) model that assumes the reactor product composition to be representative of the composition within the reactor.

The generic equation above is solved separately for each of the four hydrotreating reaction mechanisms “i.” In other words, the equation is solved separately for desulphurization, denitrogenation, olefinic hydrogenation and aromatic hydrogenation. Reactants “Xᵢ” for each reaction mechanism are as follows: organic sulfur compounds for desulfurization; organic nitrogen compounds for denitrogenation; olefinic compounds for olefinic hydrogenation; and aromatic compounds for aromatic hydrogenation. The values for “K1ᵢ” and “Eaᵢ” will vary for each different hydrotreating reaction “i” on a given feed. The values of “K2ᵢ” and K3ᵢ” may vary for different hydrotreating reactions “i” on a given feed. The activation energies (Eaᵢ) can be found in open literature and are often adjusted to best match plant data. All the rate constants (i.e., “K1ᵢ,” “K2ᵢ”, and “K3ᵢ”) are empirical and are tuned to plant data, often requiring a plant step test where a sudden change is introduced into the unit and the unit's response is monitored (i.e., a sensitivity analysis).

Once the rate of hydrogen consumption for each of the individual reaction mechanism is known, the total rate of hydrogen consumption by a given hydrotreating reactor can be calculated in the following manner:

ν_{HTU}=Σν_{HT,i}=ν_{OISat}+ν_{ArSat}+ν_{DS}+ν_{DN}

where “ν_{HTU}” is the total rate of hydrogen consumption by the hydrotreating unit, “ν_{OISat}” is the hydrogen consumption rate of the unit for saturation of olefinic compounds, “ν_{ArSat}” is the hydrogen consumption rate of the unit for saturation of aromatic compounds, “ν_{DS}” is the hydrogen consumption rate for desulforization of organic sulfur and “ν_{DN}” is the hydrogen consumption rate for denitrogenation of organic nitrogen. In other words, the total rate of hydrogen consumption of a hydrotreating reactor is the sum of the hydrogen consumption rates for each of the four hydrotreating reaction mechanisms.

### Modeling Hydrocracking Reactors

A hydrocracker does everything a hydrotreater does plus hydrocracking reactions. The additional hydrocracking reactions are substitution reactions that occur in the presence of hydrogen. More particularly, hydrogen ions destabilize carbon bonds in the predominately hydrocarbon feed (generally C₆₊), causing them to break into smaller molecules (C₁-C₅) that are then saturated. Therefore, these hydrocracking reactions can be characterized by the substitution of hydrocarbon functional groups in the bulk oil with hydrogen. The generation of C₁, C₂, C₃, C₄ and C₅ hydrocarbon products occurs simultaneously inside each hydrocracking reactor and should be represented in the model.

The hydrocracking reactor models are rigorous custom models that utilize Arhenius type equations to calculate the hydrogen consumption needs of each hydrocracking unit represented. Thus, the reactor models include both the hydrotreating equations discussed previously as well as customized kinetic models for the hydrocracking reactions in a fashion that focuses on accurately describing the impact of process changes on light gases only. For each hydrocracking unit, the rate of hydrogen consumption required to perform each of the hydrotreating reactions and to generate each of the C₁-C₅ products is a function of key properties of the reactor and the feed to the reactor. The key reactor properties include reactor operating temperature, pressure and residence time. The key feed properties include light gas phase species (i.e., H₂, H₂S and NH₃) which are important in order to capture inhibition effects.

The formula for determining the actual hydrogen consumption rate in a given hydrocracking reactor for the generation of C₁, C₂, C₃, C₄ and C₅ hydrocarbon products can be generically expressed as follows:

ν_{HC,i}={K4ᵢ*Pres*e^{(-Ea/Temp)/LHSV*[H}₂]/(K5*[H₂S]+K6*[NH₃]+1.0)}*[Y]

where “ν_{HC,i}” is the rate of hydrogen consumption for the generation of a hydrocracking product “i” on a given feed flowing to the reactor, where “K4ᵢ” is an arbitrary rate constant that represents the overall activity of the hydrocracking reaction tuned online to match hourly changes in plant operation, where “Pres” is the pressure in the reactor, where “Ea” is the activation energy for the hydrocracking reaction tuned off line to match plant test data (i.e., tuned manually when additional data from lab analysis is available), where Temp” is the temperature of the reactor, where “LHSV” is the liquid hourly space velocity or residence time in the reactor, where “[H₂]” is the mole fraction of hydrogen gas in the reactor as measured by analyzing product from the reactor, where “K5” is an inhibition factor for the hydrocracking reaction due to the presence of H₂S in the reactor and, like the activation energy, is tuned off line to match plant test data (a higher K5 means more inhibition), where “[H₂S]” is the mole fraction of hydrogen sulfide in the reactor as measured by analyzing product from the reactor, where “K6” is an inhibition factor for the hydrocracking reaction due to the presence of NH₃ in the reactor and, like the activation energy, is tuned off line to match plant test data (a higher K6 means more inhibition), where “[NH₃]” is the mole fraction of ammonia in the reactor as measured by analyzing product from the reactor and where “[Y]” is the mole fraction of C₆₊ product in the reactor as measured by analyzing product from the reactor. As evident, this is a CSTR model that assumes the reactor product composition to be representative of the composition within the reactor.

The generic equation above is solved separately for each hydrocracking product “i.” In other words, the equation is solved separately for the generation of C₁, C₂, C₃, C₄ and C₅ hydrocarbons. Only the value of “K4” changes between the equations. The values of the remaining variables remain the same. The activation energy “Ea” can be found in open literature and is often adjusted to best match plant data. All the rate constants (i.e., “K4ᵢ,” “K5,” and “K6”) are empirical and are tuned to plant data, often requiring a plant step test where a sudden change is introduced into the unit and the unit's response is monitored (i.e., a sensitivity analysis).

Once the hydrogen consumption for the generation of each of the different hydrocracking products is known, the total rate of hydrogen consumption for the hydrocracking reactions in the hydrocracker can be calculated in the following manner:

ν_{HC}=Σν_{HC,i}=ν_{C1}+ν_{C2}+ν_{C3}+ν_{C4}+ν_{C5}

where “ν_{HC}” is the total rate of hydrogen consumption for the hydrocracking reactions in the hydrocracking unit, “ν_{C1}” is the hydrogen consumption rate for C₁ hydrocarbon generation, “ν_{C2}” is the hydrogen consumption rate for C₂ hydrocarbon generation; “ν_{C3}” is the hydrogen consumption rate for C₃ hydrocarbon generation, “ν_{C4}” is the hydrogen consumption rate for C₄ hydrocarbon generation; and “ν_{C5}” is the hydrogen consumption rate for C₅ hydrocarbon generation. In other words, the actual hydrogen consumption rate for the hydrocracking reactions in the hydrocracking unit is the sum of the hydrogen consumption rates for generating each of the hydrocracking products.

Once the total rate of hydrogen consumption for the hydrocracking reactions in the hydrocracking unit is known, the total rate of hydrogen consumption in the hydrocracking unit can be calculated in the following manner:

ν_{HCU}=ν_{HC}+ν_{HT}

where “ν_{HCU}” is the total rate of hydrogen consumption of the hydrocracking unit, “ν_{HC}” is the total hydrogen consumption rate for hydrocracking reactions in the hydrocracking unit and “ν_{HT}” is the total hydrogen consumption rate for the hydrotreating reactions in the hydrocracking unit (calculated in the same manner as “ν_{HTU}” above).

### Modeling H2 Plant Reactors

The H2 reactor is a custom first principles model designed to represent each of the reactors present in a typical hydrogen production facility. The model simulates the kinetics (both reversible and irreversible reactions), heat effects and catalyst activity. The model is capable of predicting product yield/composition based on varying heat input and/or feed composition.

In a H2 plant, hydrocarbon feed (typically C₁ through C₆) is converted to CO, H₂, CO₂, CH₄ and H₂O. Unlike the hydroprocessing reactor model, it is important to rigorously model all the molecular species as well as the energy balance. The reactors modeled include the steam cracker, the water-gas shift converters and the methanator.

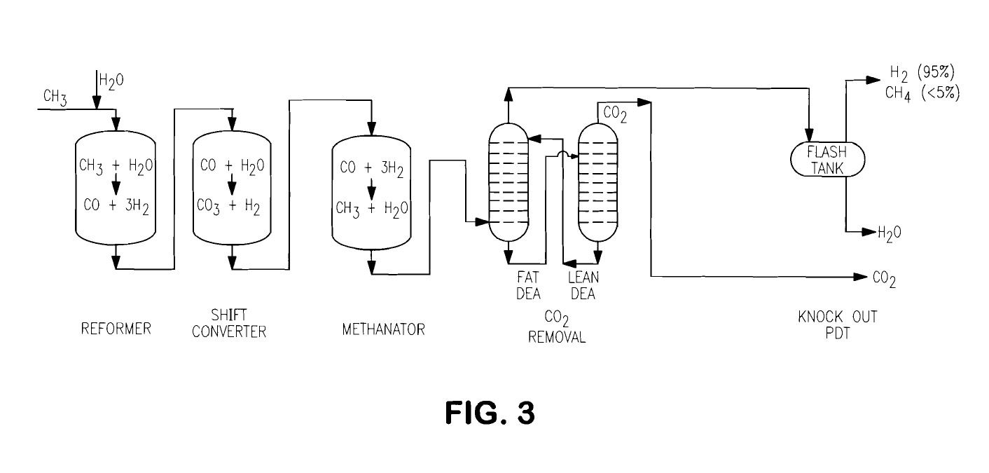

FIG. 3 shows an illustrative H₂ plant set up. Referring to FIG. 3, the process begins in a steam cracker (a.k.a., a reformer) where hydrocarbon feed (e.g., CH₄) and steam (H₂O) are passed over a catalyst at high temperature (e.g., 1500° F.) to form carbon monoxide (CO) and hydrogen gas (H₂). The hydrogen gas concentration of this product is relatively low and, in a refinery, not much use can be found for carbon monoxide. Accordingly, in the next step one or more water-gas shift converters are typically employed to increase the hydrogen gas yield by converting the carbon monoxide into carbon dioxide (CO₂) and making more hydrogen gas in the process. This is generally done by passing the steam cracker product over another catalyst at high temperature (e.g., 650° F.) in the presence of more steam. At this point, the product stream is composed of a relatively high purity hydrogen gas with trace quantities of carbon monoxide. Since carbon monoxide can deactivate downstream catalyst in many refinery applications, the gas product is then sent to a methanator which uses catalyst and high temperature (e.g., 800° F.) to convert the remaining carbon monoxide in the gas product into methane (CH₄).

Overall the reactions in this system can be described as:

CₓH_{y}+xH₂O←→xCO+[x+(y/2)]H₂ (steam reforming)

CO+H₂O←→CO₂+H₂ (water/gas shift)

CO+3H₂←→CH4+H₂O (methanation)

The resulting process stream consists of mostly H₂, CO₂, CH₄ and steam. Typically, the gas product is then purified to remove the carbon dioxide using one or more scrubbers. The scrubbers, in this instance, need not be rigorously modeled because there is not much optimization opportunity—instead, key constraints such as the minimum and maximum CO₂ removal are captured. The stream is then removed by a flash tank. The end result is a relatively pure H₂ stream with a minor amount (<5%) methane.

The H₂ reactor model developed for this technology rigorously models all of these reaction mechanisms. Note that steam reforming is heavily endothermic and the utility cost of providing that energy is high. Thus these reactor models rigorously model the energy balance. Each of the H₂ reactor model components is described individually in more detail below:

### Steam Reforming

The first modeled reaction is steam reforming. The overall rate of decomposition of hydrocarbons to carbon monoxide and hydrogen gas can be expressed as follows:

ν_{reform,i}=Kᵢ*[Cᵢ]*exp[Ea/(R_{gas}Temp)

where “ν_{reform,i}” is the rate of decomposition of each hydrocarbon species “i” (e.g., C₁, C₂, C₃, C₄, C₅ or C₆) in the reactor, “Kᵢ” a generic reaction rate constant, “[Cᵢ]” is the concentration of each hydrocarbon species in the reactor as measured by analyzing product from the reactor, “Ea” is the activation energy for the reaction, “R_{gas}” is the universal gas constant, and “Temp” is the temperature of the reaction. This equation is solved for each hydrocarbon species “i” in the reactor (e.g., each of C₁ through C₆).

### Water/Gas Shift

The second modeled reaction is water/gas shift. This is a reversible reaction that results in an equilibrium mixture of reactants (i.e., carbon monoxide and steam) and products (i.e., carbon dioxide and hydrogen gas). The forward water/gas shift reaction rate can be represented by the following formula:

ν_{wgs forward}=Kᵣₐₜₑ*P_{CO}*P_{H2O}

where “ν_{wgs forward}” is the forward rate of reaction, “Kᵣₐₜₑ” is a forward rate multiplier calculated in the manner defined below, “P_{CO}” is the partial pressure of carbon monoxide in the reactor as measured by analyzing product from the reactor and “P_{H20}” is the partial pressure of steam in the reactor as measured by analyzing product from the reactor.

The reverse water/gas shift reaction rate can be represented by the following formula:

ν_{wgs reverse}=Kᵣₐₜₑ/K_{eq}*P_{CO2}*P_{H2}

where “ν_{wgs reverse}” is the reverse rate of reaction, “Kᵣₐₜₑ” is a reverse rate multiplier calculated in the manner define below, “K_{eg}” is the equilibrium constant and calculated in the manner defined below, “P_{CO2}” is the partial pressure of carbon dioxide in the reactor as measured by analyzing product from the reactor and “P_{H2}” is the partial pressure of hydrogen gas in the reactor as measured by analyzing product from the reactor.

For the forward and the reverse water/gas shift reaction rates, the variable “Kᵣₐₜₑ” can be calculated as follows:

Kᵣₐₜₑ=W_{cat}*K*exp[Ea/(R_{gas}Temp)]

where “W_{cat}” is the weight of the water/gas shift catalyst, “K” is a generic rate constant tuned off-line to plant data, “Ea” is the activation energy of the reaction, “R_{gas}” is the universal gas constant and “Temp” is the actual temperature of the reactor.

For the reverse water/gas shift reaction rate, the equilibrium constant “K_{eq}” can be calculated as follows:

K_{eq}=K_{eq ref}*exp[Hᵣ*(1/Temp−1/Temp_{ref})/R_{gas}]

where “K_{eq ref}” is an equilibrium constant for the reaction as determined from a text or in the lab at a given temperature, “Hᵣ’ is the heat of reaction, “Temp” is actual temperature of the reactor. “Temp_{ref}” is the reference temperature at which the heat of reaction was determined, and “R_{gas}” is the universal gas constant.

### Methanation

The third modeled reaction is methanation. This is a reversible reaction that results in an equilibrium mixture of reactants (i.e., carbon monoxide and hydrogen gas) and products (i.e., methane and steam).

The forward methanation reaction rate can be represented by the following formula:

ν_{meth forward}=Kᵣₐₜₑ*P_{CH4}*P_{H2O}

where “Kᵣₐₜₑ” is a forward rate multiplier calculated in the manner described below, “P_{CH4}” is the partial pressure of methane in the reactor as measured by analyzing product from the reactor and “P_{H2}” is the partial pressure of steam in the reactor as measured by analyzing product from the reactor.

The reverse methanation reaction rate can be represented by the following formula:

Rᵣₑᵥₑᵣₛₑ=Kᵣₐₜₑ/K_{eq}*P_{H2}³*P_{CO}

where “Kᵣₐₜₑ” is a reverse rate multiplier calculated in the manner described below, “K_{eq}” is the equilibrium constant and calculated in the manner described below, “P_{H2}” is the partial pressure of hydrogen gas in the reactor as measured by analyzing product from the reactor and “P_{CO}” is the partial pressure of carbon monoxide in the reactor as measured by analyzing product from the reactor.

For the forward and the reverse methanation reaction rates, the variable “Kᵣₐₜₑ” can be calculated as follows:

Kᵣₐₜₑ=W_{cat}*K*exp[Ea/(R_{gas}Temp)]

where “W_{cat}” is the weight of the methanation catalyst, “K” is a generic rate constant tuned off line to plant data, “Ea” is the activation energy of the reaction, “R_{gas}” is the universal gas constant and “Temp” is the actual temperature of the reactor.

For the reverse methanation reaction rate, the equilibrium constant “K_{eq}” can be calculated as follows:

K_{eq}=K*exp[Hᵣ*(1/Temp−1/Temp_{ref})/R_{gas}]

where “K_{eq ref}” is an equilibrium constant for the reaction as determined from a text or in the lab at a given temperature, “Hᵣ” is the heat of reaction, “Temp” is the actual temperature of the reactor, “Temp_{ref}” is the reference temperature at which the heat of reaction was determined, and “R_{gas}” is the universal gas constant.

### Overall Mass Balance Equations

The net rate of production or consumption of a species can be determined by summing the above reforming, water/gas shift and methanation rates with the appropriate stoichiometry. For example, in the case of hydrogen, the net rate of production (“ν_{H2 prod}”) would be calculated in the following manner:

ν_{H2 prod}=3*ν_{meth,forward}−ν_{meth,reverse}+ν_{wgs,forward}−ν_{wgs,reverse}+Σᵢ[(xᵢyᵢ/2)*ν_{reform,i}]

Similar equations can be constructed for the net rate of production or consumption of H₂O, CO, CO₂, CH₄ and other hydrocarbon species. These rates are then used to solve the overall mass balance. Again, using hydrogen as an example:

Mass Hydrogen out=Mass Hydrogen in+ν_{H2} production

### Modeling Hydrogen Distribution Headers

Hydrogen gas distribution among the many suppliers and consumers in a refinery is handled by a distribution header or pipeline. Several hydrogen gas suppliers feed into a common header at different points. The composition and flow rate of each hydrogen gas feed may be different and may vary over time since some sources provide a relatively pure hydrogen gas stream and other sources provide hydrogen gas mixed with different combinations of other light gases. Each consumer draws off from the header at a different point and the demand from each consumer can vary over time (e.g., as a result of unit RTO actions and changing unit feed composition). Because the hydrogen gas leaves the header from different locations, it is never completely mixed. Therefore, each hydrogen gas consumer receives hydrogen of a different purity level depending, largely, on where the consumer draws hydrogen.

The custom hydrogen header model is a relatively simple algebraic model that calculates flow distribution among the various feed and product streams in the header. The composition of the hydrogen gas drawn by a given consumer will be impacted most by the hydrogen gas that enters the header at a point closest to the point where the consumer draws hydrogen gas. Demand is satisfied based on a pressure balance around the unit. This establishes a priority order for the product streams.

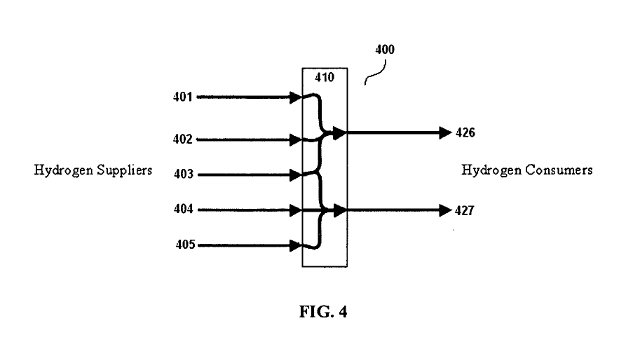

FIG. 4 is illustrative. FIG. 4 shows a hydrogen header configuration 400. The configuration has five hydrogen gas suppliers 401, 402, 403, 404 and 405 flowing into the header 410 and two hydrogen gas consumers 426 and 427 pulling from the header 410. In FIG. 4, the hydrogen consumer on stream 426 might be the dominant consumer. In such a case, the model will satisfy its flow demand for the hydrogen consumer on stream 426 first with flow from the hydrogen supplier on stream 401, then 402, and so on, until the flow demand of the hydrogen consumer on stream 426 is met. If streams 401, 402 and part of 403 are sufficient to meet the flow demand of the hydrogen consumer on stream 426, then any remaining flow—namely, stream 403 (whatever remains after satisfying stream 406 demand), stream 404, and stream 405—will feed the hydrogen consumer on stream 427. Therefore, as the flow demand for the hydrogen consumer on stream 426 changes, the compositions for both hydrogen consumers 426 and 427 will change as well as the flow rate on stream 427.

### Modeling Membranes

As high purity hydrogen streams are used their purity drops, but the streams still contain a significant amount of hydrogen. Therefore, hydrogen systems often contain membrane separation units to remove contaminants and increase the purity of hydrogen streams.

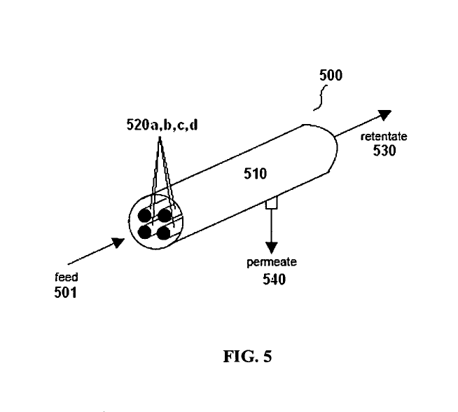

FIG. 5 illustrates a typical membrane separation unit 500. The membrane separation unit 500 comprises one or more bundles (in this case one bundle labeled 510) of multiple membrane tubes (in this case four labeled 520a, 520b, 520c, and 520d). Hydrogen containing feed stream 501 flows across bundle 510. A retenate 530 exits in one direction and a permeate 540 exits in another. Typically, the permeate is a higher purity hydrogen stream.

The membrane separation model is a custom first principles based model that rigorously characterizes the feed and kinetics of the separation process. The model allows optimization of feed rate, feed mix, and process conditions subject to various operating constraints (such as dew point). The expression for the rate of each light gas species crossing the membrane is calculated as follows:

ν_{permeate,i}=#Tubes*K7*Pᵢ*e^{(Ea}^{ᵢ}^{Temp)}*(1/FlowRate)^{0.5}*(Xᵢ*Pres₁−Yᵢ*Pres₂)

where “ν_{permeate, i}” is the rate at which a species “i” that enters the permeate, “#Tubes” is the total number of tubes that comprise the membrane, “K7” is a rate constant tuned off-line that accounts for tube surface area, “Pᵢ” is the permeability of species “i” across the membrane, “Eaᵢ” is the activation energy of for each species crossing the membrane, “Temp” is the temperature of the membrane unit, “Flowrate” is the flow rate through the membrane, “Xᵢ” is the mole fraction of species “i” on the feed side of the membrane, “Pres₁” is the pressure on the feed side of the membrane, Yᵢ is the mole fraction of species “i” on the permeate product side of the membrane,” and “Pres₂” is the pressure on the permeate product side of the membrane.

To determine the rate and composition of the permeate product formed, the aforementioned formula is separately solved for each of the light gas species that cross the membrane (i.e., each of C₁-Cₐ, NH₃, H₂S, H₂, H₂O, Cₒ, and CO₂). Preferably, the membrane is modeled as a plug flow. In other words, the molecules are represented as radially uniform and moving in a straight line with no coaxial backtracking. Preferably, the concentration of each light gas molecule is calculated multiple times at multiple points along the length of the membrane unit. In other words, the model of the membrane is preferably a compilation of multiple models of the separation activity at multiple points along the membrane. This rigorous tracking of composition allows the model to predict whether any constraints, such as dew point (i.e., liquid water) constraints, of the membrane are breached by a feasible solution.

### Modeling PSA and CO₂ Scrubbers

Hydrogen purification models such as PSA or CO₂ scrubbers can be represented using standard library models available in most RTO software design packages (e.g., ROMeo or DMO). Only a simple model is needed to capture either a constant efficiency or efficiency as a function of one or more process conditions (e.g., temperature, residence time, etc.). In these cases a “component splitter” model is typically used where, for example, the CO₂ removal efficiency is specified. The form for this equation is application specific and varies, but a typical example would be:

CO₂ removal efficiency=1/(K8*Temp+K9*FlowRate)

where “K8” and “K9” are arbitrary (tuned) constants, “Temp” is the reactor operating temperature, and “FlowRate” is feed flow rate.

### Modeling Valves and Compressors

Modeling constraints on changes in flow rate is important. Typically, flow rate constraints are associated with valves and compressors. Again, the valves and compressors can be represented using standard library models available in most RTO software packages (e.g., ROMeo or DMO).

The relationship between flow rate, pressure drop, and valve position can be represented with any one of a number of widely available commercial models. ROMeo, for instance, provides a suitable “valve” model. The model requires one to pick a flow equation from a number of equally suitable alternatives (e.g., the “Honeywell equation”).

For compressors, key criteria are pressure versus flow curves, RPM limits, spillback valve limitations, etc. Again, this can be done easily using commercially available models in a typical RTO software package. ROMeo, for instance, provides a suitable “compressor” model.

### Modeling Fuel Gas Furnaces

It is preferable to include some representation of the fuel gas system in the model since this is the ultimate destination of spent light gases. The furnaces are represented using standard library models available in most RTO software packages (e.g., ROMeo or DMO). Basically, each furnace model is a combustion calculation to predict the heat derived from a given amount of air and a given composition and amount of fuel gas. In addition, each furnace model includes, or should be integrated with, models of the valves and nozzles thereto and associated constraints (e.g., the molecular weight range of fuel gas required by the nozzles).

### RTO Application Using the Model

Another embodiment of the invention is an apparatus comprising a RTO computer application for a hydrogen system (H₂ system RTO) in a refinery, preferably an oil refinery. The RTO application is stored on a program storage device readable by a computer. The H₂ system RTO monitors and optimizes the supply and allocation of hydrogen gas in the hydrogen system of a refinery. Preferably, the hydrogen system is any one of the hydrogen system embodiments, or combinations thereof, previously described and, therefore, comprises one or more, and preferably multiple, supply sources that provide hydrogen at individual rates, purities, pressures and costs, multiple consumption sites that consume hydrogen at individual rates, purities and pressures and an interconnecting hydrogen distribution network.

The H₂ system RTO contains an H₂ system model. Preferably, the H₂ system model is any one of the H₂ system model embodiments set forth in the section above or combination thereof. Therefore, the model preferably comprises linked, non-linear, kinetic models that track the movement and consumption of hydrogen gas in the hydrogen system. Further, in refinery operations where, for example, an H₂ plant or other hydrogen source is under the control of the refinery, the H₂ system model may contain one or more linked, non-linear kinetic models for a hydrogen gas production plant or other hydrogen supply source that track the supply (e.g., manufacture) of hydrogen gas.

In addition, the model preferably tracks the movement and consumption of both hydrogen gas and associated light gases. More particularly, the models for the hydrogen consumption units preferably represent light gases as discrete components and lump heavier materials into key performance characteristics, including olefinic compounds, aromatic compounds, organic nitrogen and organic sulfur, that are chosen such that the models will predict the correct shift in light gases when an operational change is introduced. Typically, the H₂ system model also tracks the disposal of unused or expended hydrogen gas and associated light gases into a fuel gas system that powers the refinery.

The H₂ system RTO loads current operating data and uses said operating data to populate and calibrate the models. The H₂ system RTO also loads operating constraints (e.g., consumption requirements for the hydrogen consumers) for the hydrogen system. The H₂ system RTO then manipulates, in an iterative manner, model variables to determine feasible solutions of operating targets for the hydrogen system that meet operating constraints. In other words, the H₂ system RTO performs various “what if” tests by manipulating key degrees of freedom within the models, which correspond to key operating variables within the refinery, to produce feasible solutions given the operating constraints. Finally, the H₂ system RTO outputs a recommended solution of operating targets to move the operation of the hydrogen system toward a performance related objective function.

Accordingly, in one embodiment, the invention is an apparatus comprising a real time optimization computer application stored on a program storage device readable by a computer, wherein the application optimizes the supply and allocation of hydrogen gas in a hydrogen system of a refinery that comprises one or more supply sources that provide hydrogen at individual rates, purities, pressures and costs, multiple consumption sites that consume hydrogen at individual rates, purities and pressures and an interconnecting hydrogen distribution network, where the application comprises linked, non-linear, kinetic models for the movement and consumption hydrogen gas in the hydrogen system and where the application (a) loads current refinery operating data and uses said operating data to populate and calibrate the models, (b) loads operating constraints for the hydrogen system, (c) manipulates, in an iterative manner, model variables to determine feasible solutions of operating targets for the hydrogen system that meet operating constraints and (d) outputs a recommended solution of operating targets to move the operation of the hydrogen system toward a performance related objective function.

Preferably, the recommended solution is the optimal solution to the objective function. However, the recommended solution could also be a near optimal or more optimal solution.

The objective function can be related to any performance parameter for the hydrogen system. For instance, the objective function may be the minimization of hydrogen gas bleed to fuel gas or, conversely, the maximization of hydrogen gas fed to high value consumption units.

The objective function can also be an economic objective function. Suitable economic objective functions are the minimization of hydrogen gas supply and distribution costs or the maximization of profit.

For example, the objective function can be the minimization of cost for hydrogen supply and distribution. In this embodiment, the application typically loads economic data for calculating costs for hydrogen supply and distribution and uses said economic data to calculate said costs for each feasible solution. For example, the objective function can be calculated considering, for each feasible solution, the costs for all the feeds to the network (i.e., light gas feeds as well as heavier liquid hydrocarbon feeds to the H₂ plant), utility costs (i.e., steam, electricity) and values for all the light gas products. The H₂ System RTO then typically determines, for each feasible shift in plant operation, the total cost and then determines a more optimal shift that minimizes cost while meeting the consumption requirements of the hydrogen consumers and other operating constraints.

Alternatively, the objective function can be the maximization of profit, where profit is based on a valuation of products made by the hydrogen consumers minus the corresponding cost of hydrogen supply and distribution. In this embodiment, the application loads economic data for calculating values for products made by the hydrogen consumption sites and for calculating the costs for hydrogen supply and distribution and uses said economic data to calculate profit as a difference between the sum of said product values and the sum of said hydrogen supply and distribution costs for each feasible solution. This embodiment typically requires economic data from the plant operator to value the refinery products (e.g., diesel, gasoline, etc. . . . ) made by each hydrogen consumer based on product specifications. More specifically, the refinery operator enters base values for each product and correlations that define changes to the base values as a function of changes in product quality that may result due to hydrogen supply changes. For example, for each hydrotreater, the refinery operator would enter values for changes (e.g., $/Δppm) in key product qualities such as nitrogen content, sulfur content, olefinic content and aromatic content. Similarly, for each hydrotreater, the refinery operator would enter values for changes (e.g., $/Δppm) in key product qualities such as C₁-C₅ content. The H₂ system RTO can determine, for each feasible shift in plant operation, the resultant delta between the value of products produced and the cost, and then determines a more optimal shift that maximizes this delta while meeting consumption requirements and operating constraints.

The H₂ system RTO runs on a conventional Windows/Unix/VMS based server or desktop computer. Preferably, the H₂ system RTO is integrated with, or in communication with, at least one refinery process control system, and runs automatically on a regular periodic basis. Preferably, the recommended solution of operating targets is automatically communicated and implemented by the process control system. However, the recommended solution of operating targets could also be communicated to any plant operator computer or process control for review and approval by a plant operator prior to implementation. The process control system can be a basic process controller or a model-based, multivariable process controller such as a Dynamic Matrix Control (DMC).

The H₂ system RTO can be set up to run automatically on a regular periodic basis. Preferably, the H₂ system RTO is run automatically at least once every hour and, more preferably, at least once every 15 to 30 minutes. However, the H₂ system RTO can be run as fast as every 1 to 10 minutes.

More particularly, the H₂ system RTO can perform each of the following functions:

### Operating Data

Once the fundamental structure and connectivity of the H₂ system model for the H₂ system RTO has been constructed, and when the plant operation is in steady-state, the H₂ system RTO pulls data regarding current operating conditions within the refinery from at least one, and possibly more than one, process control system (e.g., a DMC) via an external data interface. In other words, the application pulls real time data regarding the operation of the refinery. The model variables corresponding to key plant measurements are then defined by the live plant data. Typical plant data downloaded for this purpose includes process measurement data on reactor conditions (temperatures, pressures, flowrates), compressor speed, valve positions, flowrates throughout the network, product quality requirements (e.g., product sulfur, nitrogen, distillation curve and specific gravity), and feed availability for the H₂ plant and composition. Typically, this data is pulled from a process control system or other plant data historian and, for the most part, it is ultimately derived from on-line analyzers positioned throughout the refinery. Preferably, this operating data is loaded automatically.

When current operating conditions are loaded into the H₂ system model, the H₂ system RTO then undergoes a calibration step whereby gross measurement data errors are detected and key variables in the model are selected and manipulated to produce a ‘best fit’ with the measurement data. In other words, the H₂ system RTO tunes the model by selecting values for constants and other variables (e.g., tuning constants) that reconcile model predictions with actual operating data. This step can be performed using any one of a number of suitable mathematical methods for performing data reconciliation known to those skilled in the art. This plant data acquisition and model tuning procedure can be automated using the “Real Time System” (RTS) of ROMeo. Resulting deviations between model predictions and plant data, and related model tuning parameters are then historized, for trending, analysis and model fit improvement.

### Economic Data

If the objective function is an economic objective function then, simultaneously, the H₂ system RTO loads relevant economic data for economically measuring potential feasible solutions. This economic data would typically includes the cost of purchased hydrogen at different pressures (e.g., tier pricing), the costs associated with running the hydrogen plant (e.g., the feed cost), the costs associated running each compressor (e.g., steam, electric costs), each membrane operation (e.g., compressor costs), and furnace duties for fuel gas (including any environmental penalties if excess fuel gas is sent to flare). For larger compressors, operating costs should be included as a function of flow rate. In addition, if the economic objective function is profit, this data would also typically include base values and valuations for changes in refinery products that may result due to changes in hydrogen supply to hydrogen consumers. Typically, this data is pulled from a process control system or other plant data historian—but it is ultimately derived from plant operator inputs. Economic data can also be loaded directly using a user interface. Preferably, this economic data is loaded automatically.

### Constraints

When the H₂ system RTO models have been calibrated to current operating conditions, the relevant constraints for the optimization problem are loaded. The constraints are the conditions that a solution to the optimization problem must satisfy. Like the current operating conditions, the operating constraints are typically loaded into the H₂ system RTO from a process control system or other plant data historian where they have been previously entered by the refinery operator to define the allowable operating window of the plant. Constraints can also be loaded directly using a user interface. Preferably, the constraints are loaded automatically.

Constraints for a simple hydrotreater or hydrocracker which affect hydrogen demand include the following: flow rates of gas feeds; products and effluents; temperatures of reactor inlet, outlet, hot separator and cold separator; pressures of reactor, hot separator and cold separator; valve positions of control elements (any valves in the hydrotreating unit are potential constraints); and measured or calculated operating conditions such as treat-gas ratio, reactor hydrogen partial pressure, reactor effective isothermal temperature (EIT), flow velocity, equipment duties, and stream qualities and purities (e.g., sulfur content, nitrogen content, distillation curves, specific gravity).

Constraints for a simple H₂ plant that affect hydrogen supply include the following: reactor operating temperatures, feed hydrogen to carbon (H/C) ratio, steam rates, hydrogen product purity, CO/CO₂ purity, and furnace/fuel gas limitations.

The constraints found in the general piping network of a refinery hydrogen system relate principally to maintaining control of the system and managing inventory. More specifically, constraints encountered relating to control include high and low ranges for temperature, pressure and other measurements and control device range limitations (e.g., valve positions). Constraints encountered relating to managing inventory of the system would include line velocity limitations, allowable pressure ranges, liquid level ranges in vessels and any considerations related to flow direction. Compressor constraints (spill back loops, etc.) are also often an important constraint on this type of system and should be modeled appropriately.

The furnace constraints include the valve and nozzle constraints leading to the furnace. These include valve position, pressure drop, fuel molecular weight and metallurgy limitations (e.g., temperature limitations).

### Optimization

At this point, a new set of improved, and preferably, optimal operating points for the hydrogen system can be calculated. Key degrees of freedom within the models, which correspond to key operating variables within the process plant, are manipulated to generate different feasible solutions (i.e., different solutions that meet the constraints), which are then compared to achieve the objective function subject to imposed constraints. In other words, the H₂ system RTO, in an iterative manner, continuously runs different “what if” scenarios using the models described above to characterize the hydrogen system under different operating targets and then evaluates the same relative to the objective function. Illustrative operating targets include flow controller settings for distributing H₂ across the network to consumers, pressure controller settings to move H₂ distribution across specific lines in the H₂ network, flow meter settings for the purchase of high and low pressure H₂ from third parties (e.g., Air Products etc.), temperature controller settings, valve position settings, compressor speeds, stream purities and the like.

For example, if the objective function is the minimization of cost, then for each feasible solution the H₂ system RTO calculates the overall cost of the solution. Alternatively, if the objective function is the maximization of profit, then for each feasible solution the H₂ system RTO calculates the overall profit of the solution. Each time, the H₂ system RTO compares the economics of the newest feasible solution to the last best feasible solution to determine whether the new feasible solution is an improvement toward achieving the objective function. This process continues until the process is manually terminated or all feasible solutions have been evaluated and the optimal solution has been identified.

The H₂ system RTO optimizes hydrogen supply by optimizing hydrogen purchases from third parties as well as the operating severity of the hydrogen product plant (if present) and feed thereto. The H₂ system RTO optimizes hydrogen distribution by optimizing the hydrogen balance to fuel gas, as well as the purification processes (e.g., membranes and PSAs) and compression to reduce overall system costs. The H₂ system RTO optimizes hydrogen consumption by decreasing or increasing the purity and flow rate of hydrogen fed to consumption units within constraints required by the unit. Finally, the H₂ system RTO optimizes the fuel gas system by optimizing a combination of flow rate and calorific value for the light gas supply to the furnaces while maintaining demanded duty, and reducing material to flare.

Often the energy requirements of the various processes and the energy content of the gas being sent to flare cannot be effected—however, this application can discriminate between the various molecules providing that energy and, given available degrees of freedom, choose the best disposition for each molecular type. For example, if C₄'s are particularly valuable, the H₂ system RTO may be able to save these molecules from going to a furnace by replacing them with an equivalent amount on a heating value ($/btu) basis of a lower value molecule (such as CH₄). Reducing the flow of high value molecules to flare can be a significant benefit of the application of this technology.

### Output

The output of the H₂ system RTO is a consistent set of operating settings/targets that represent an improved, and preferably optimal, steady-state for the hydrogen system. Again, illustrative operating targets include flow controller settings for distributing H₂ across the network to consumers, pressure controller settings to move H₂ distribution across specific lines in the H₂ network, flow meter settings for the purchase of high and low pressure H₂ from third parties (e.g., Air Products etc.), temperature controller settings, valve position settings, compressor speeds, stream purities and the like. Typically, the H₂ system RTO provides updates for somewhere between 30 and 50 targets, which are then implemented and enforced by the process control system. The H₂ system RTO communicates these operating targets to a process control system or some other plant operation computer for automatic or manual implementation. Preferably, this communication is done automatically on-line.

### Implementation

In one embodiment, the H₂ system RTO solution is communicated to, and implemented automatically on-line by, a process control system such as a basic process controller or model based multi-variable process controller. In this way, the operating targets of the solution can be achieved in a controlled fashion, as the process control system takes account of the dynamics of the process whilst moving base level controllers to the new set-points. A new optimal can be reached quickly and with minimal constraint violation, either transiently or at steady-state.

Alternatively, or in addition, the H₂ system RTO can be used in an advisory mode. In this embodiment, the operating targets of the solution are sent to and displayed in a plant operator computer or process control system. The plant operator then reviews and approves the new optima and implements them, typically via a process control system. Again, the process control system can be a basic process controller or a model based, multi-variable process controller such as a DMC.

Typically, the H₂ system RTO provides updates that are implemented and enforced, minute-by-minute, by the process control system. Typically, in response to frequent reformer regeneration swings, as well as H₂ compressor failures and other supply disruptions, the process control system will temporarily adjust purchased H₂ and/or purge to preempt and smooth H₂ system fluctuations. Relying on the H₂ system RTO for guidance, the process control system will also adjust pressure levels in the H₂ system to maintain the desired flow distribution, consistent with the optimal H₂ quantity and purity established for each consumer.

### Process Control

Under normal circumstances, when solving an optimization problem, process control is handled by some form of advanced process control, utilizing some form of basic process controller or model-based, multivariable process controller (e.g., a DMC). In other words, the process controller has constraints and, normally, the H₂ system RTO is built to respect the same constraints.

However, it is not uncommon, for a variety of reasons including intentional decisions by the plant operator to maximize some aspect of plant operations, for DMC constraints to be violated. In such cases, the H₂ system RTO will recognize a violated constraint from the plant data and use the violated constraint as a new limit—but the H₂ system RTO will not make the problem worse. Constraint violations due to operational infeasibility are, therefore, modeled as relaxed bounds, the assumption being that the underlying regulatory process controller will be independently trying to move the operation back within bounds.

Unfortunately, in some cases, this may cause problems. The H₂ system RTO is always going to try to find an optimal, which means the H₂ system RTO will always push to the limit of some constraints. Sometimes repeatedly hitting a relaxed constraint can be detrimental. For instance, if a constraint is 10, the H₂ system RTO may recommend 9.999. The process control system may then implement the change imperfectly as 10.001. The next time the H₂ system RTO runs, it assumes the relaxed constraint is 10.001 and recommends 10.0, which the process control then imperfectly implements as 10.002. In this iterative manner, the cooperation between the RTO and the DMC, results in a constraint being violated more and more every cycle. For this reason, the standard relaxed bound philosophy can be inadequate for certain variables within a hydrogen system on-line optimizer.

Therefore, in one embodiment, the H₂ system RTO possesses some independent process control. More particularly, penalties are assigned to feasible solutions that fail to comply with specified variable limits. The amount of each penalty depends on the identity of the variable limit violated and the degree of the violation.

For example, for certain variables, the models can be built to provide economic incentives for the RTO to alleviate bound violations. Such models can be generally referred as penalty functions. In this way, the RTO can make integrated moves to correct bound violations, emulating the action of a multivariable process controller. Limits that the optimizer is to consider (usually limits read in from the process control system) are read into the penalty function as bounds on the function value: only outside of the specified bounds does the function contribute to the object function. By penalizing the objective function, a driving force is created to move the variable in question towards the violated limit.

In this way, penalty models behave in a way analogous to soft bounds or violation variables. The penalty calculated is applied to the objective function (usually, the economic objective function used in the optimization solution). The penalty magnitude is controlled using the appropriate weight. If they are known, genuine economic penalties for the violations can be specified. However, because they are not always known, and to improve solution robustness, often penalty function weights are arbitrarily set to be several times the effective cost of the move expected to correct the violation. Specifying the weight like this gives a consistent drive to alleviate the violation if possible. As an example, in a case where the ultimate move is to purchase hydrogen from a supplier, the penalty function weight could be set to be some multiplier of the purchase cost.

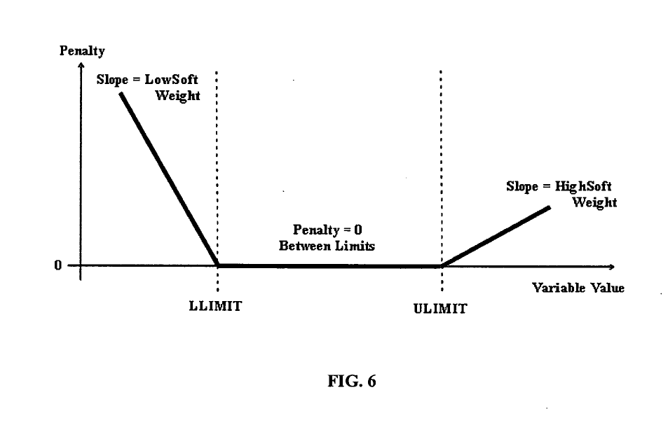

FIG. 6 illustrates this concept. FIG. 6 is a graph where the x axis represents a variable value and the y axis represents an economic penalty value. The variable has two limits, namely, a lower limit (LLIMIT) and an upper limit (ULIMIT). As long as a feasible solution maintains the variable value within these limits, the penalty assigned to the solution is zero. However, if the feasible solution requires the variable value to fall below the lower limit (LLIMIT) or above the upper limit (ULIMIT), then an economic penalty is assigned. The farther outside these limits, the higher the penalty. A slope defines the weight of the penalty per degree for violating the lower limit (Slope=LowSoft Weight) the upper limit (Slope-HighSoft Weight). As shown in FIG. 6 by the different slopes, a violation of the lower bound can be weighed differently than a violation of the upper bound. Further, the weights assigned typically vary from variable to variable.

### External Predictions

The H₂ system RTO can be run at a much high frequency than might be expected. While a normal RTO might run once every few hours, a H₂ system RTO may be run once every 1-10 minutes.

In a conventional RTO, the RTO solves a steady-state problem—delegating the responsibility of transient control to the underlying control system. However, in the case of the current invention, the high run frequency may require the H₂ system RTO to understand these transients. In such cases, ignoring process dynamics and implementing solutions at a rate faster than the “time to steady-state” of the system can result in significant controller issues. Accordingly, in one embodiment, the H₂ system RTO uses externally calculated model predictions of transient response. More particularly, constraints for some variables are adjusted based on a prediction of transient response.

The predictions become important during the optimization case, where the maximum allowed moves have to account for this transient response. In this way, the optimization case take into account the future value of the variable, as predicted by this external calculation. Thus the calculation would be as follows:

Max allowed move=(Constraint-Measurement)−Predicted Transient Response

For example, if the H₂ system RTO wanted to increase a reactor operating temperature (with a measured value of 900° F.) with a constraint (upper limit) of 920° F., but the “predicted” externally calculated transient response was +5° F., then the maximum increase the RTO could perform would be 15° F.

Configuration of this functionality in a H₂ system RTO involves the use of two measured values for the variable in question: one to represent the current value for use during model calibration and another reading in the predicted value for use during optimization. Only the measurement representing the current value should be weighted in the model calibration objective function—as the expectation is to have a non zero offset between the predicted and current values, the model calibration case should not be attempting to minimize it. Accordingly, the weight of the predicted value offset versus the model should be set to zero. The model calibration case will then calibrate the model to current operating conditions as required and be unaffected by the presence of the predicted value, except to calculate its offset.

Computer Loaded with the RTO

Yet another embodiment of the invention is an apparatus comprising a computer loaded with an RTO computer application. For example, the H₂ system RTO can be loaded and run on a conventional Windows/Unix/VMS based server or desktop computer.

The RTO computer application is any embodiment of the RTO computer application described above or any combination thereof. The RTO application optimizes the supply and allocation of hydrogen gas in a hydrogen system of a refinery. Preferably, the hydrogen system is any one of the hydrogen system embodiments, or combinations thereof, previously described and, therefore, comprises one or more, and preferably multiple, supply sources that provide hydrogen at individual rates, purities, pressures and costs, multiple consumption sites that consume hydrogen at individual rates, purities and pressures and an interconnecting hydrogen distribution network.

As previously stated, the RTO application preferably comprises linked, non-linear, kinetic models for the movement and consumption hydrogen gas in the hydrogen system and the application (a) loads current refinery operating data and uses said operating data to populate and calibrate the models, (b) loads operating constraints for the hydrogen system, (c) manipulates, in an iterative manner, model variables to determine feasible solutions of operating targets for the hydrogen system that meet operating constraints and (d) outputs a recommended solution of operating targets to move the operation of the hydrogen system toward a performance related objective function.

### Method

Yet another embodiment of the invention is a method of controlling the supply and allocation and, thereby, consumption, of hydrogen gas in a hydrogen system of a refinery, preferably an oil refinery. Preferably, the hydrogen system is any one of the hydrogen system embodiments, or combinations thereof, previously described and, therefore, comprises one or more, and preferably multiple, supply sources that provide hydrogen at individual rates, purities, pressures and costs, multiple consumption sites that consume hydrogen at individual rates, purities and pressures and an interconnecting hydrogen distribution network.

The method comprises at least five computer implemented steps. The first step is activating a H₂ system RTO application. The second step is loading current refinery operating data into the application and using said operating data to populate and calibrate the models. The third step is manipulating, in an iterative manner, model variables to determine feasible solutions of operating targets for the hydrogen system that meet operating constraints. The fourth step is determining a recommended solution of operating targets that moves the hydrogen system toward a performance related objective function. The fifth step is implementing the recommended solution of operating targets using at least one process control system to change the settings for one or more control components (e.g., valves, separation membranes, scrubbers, pressure swing absorbers, compressors and the like). Preferably, the recommended solution is the optimal solution to the objective function.

Preferably, the H2 system RTO application is any one of the RTO application embodiments set forth above or combinations thereof. Accordingly, the H₂ system RTO application preferably comprises linked non-linear kinetic models that characterize the movement and consumption (and in some cases the supply if, for example, an H₂ plant exists) of hydrogen gas in the hydrogen system. Preferably, the models in the application also track the movement and consumption of associated light gases. More particularly, the models for the hydrogen consumption units represent light gases as discrete components and lump heavier materials into key performance characteristics, including olefinic compounds, aromatic compounds, organic nitrogen and organic sulfur, that are chosen such that the models will predict the correct shift in light gases when an operational change is introduced. Typically, the models would also track the disposal of unused or expended hydrogen gas and associated light gases into a fuel gas system that powers the refinery.

The objective function may be related to any performance parameter for the hydrogen system. For instance, the objective function may be the minimization of hydrogen gas bleed to fuel gas or, conversely, the maximization of hydrogen gas fed to high value consumption units. A particularly beneficial objective function is minimization of cost to supply and distribute H2 or maximization of profit, wherein profit is calculated as the difference in value between the value of products produced by the H₂ consumption units and the cost to supply and distribute the H₂.

More particularly, in one embodiment the objective function is an economic objective function. For example, the objective function may be the minimization of cost. In such case, the method will further comprise the steps of loading economic data for calculating the costs of hydrogen supply and distribution (as previously described) into the application of hydrogen supply and distribution and calculating said costs for each feasible solution. Alternatively, the objective function may be the maximization of profit. In such case, the method will further comprise the steps of loading economic data for calculating values of products made by the consumption sites (as previously described) and costs for hydrogen supply and distribution (as previously described) and calculating profit as a difference between the sum of said product values and the sum of said hydrogen supply and distribution costs for each feasible solution.

Accordingly, in a preferred embodiment, the method is a method for operating in an oil refinery, where the oil refinery comprises (i) multiple H₂ consumption units that consume H₂ in order to produce refinery products, each H₂ consumption unit having one or more control components and (ii) an H₂ distribution network that distributes H₂ to the H₂ consumption units, the H₂ distribution network also having multiple control components. The method comprises a first step of formulating a non-linear programming model that comprises an objective function and one or more constraints, wherein the objective function is for an economic parameter, wherein the quantity of refinery products produced by each H₂ consumption unit is represented as a function of the quantity of H₂ consumed by the H₂ consumption units as supplied by the H₂ distribution network and wherein the quantity of H₂ supplied by the H₂ distribution network is represented as a function comprising one or more of the flow rate, purity, temperature and pressure of the H₂ streams in the H₂ distribution network. The method comprises a second step of receiving economic data comprising the monetary value of the refinery products produced at the H₂ consumption units. The method comprises a third step of populating the non-linear programming model with the economic data. The method comprises a fourth step of receiving refinery operating data comprising at least one reactor parameter that determines a reactor condition for the H₂ consumption units and at least one operating parameter that determines the flow rate, purity, temperature and/or pressure of H₂ streams in the H₂ distribution network. The method comprises a fifth step of populating the non-linear programming model with the refinery operating data. The method comprises a sixth step of obtaining a solution to the non-linear programming model. The method comprises a seventh step of adjusting one or more control components of the H₂ distribution network and/or H₂ consumption units according to the solution obtained. The method comprises an eighth step of periodically repeating steps one through seven.

In each case, the cycle of method steps can be run automatically on a regular periodic basis. More preferably, the method steps are repeated every hour and, even more preferably, every 15 to 30 minutes. However, the H₂ system RTO can be run as fast as every 1 to 10 minutes.

Alternatively, in each case, the recommended solution of operating targets can be communicated to a plant operator computer and, upon review and approval, implemented on command by the plant operator using the process control system. Alternatively, and preferably, the recommended operating targets are automatically implemented by the process control system. Preferably, the process control system is a model based multi-variable process control system such as a DMC.

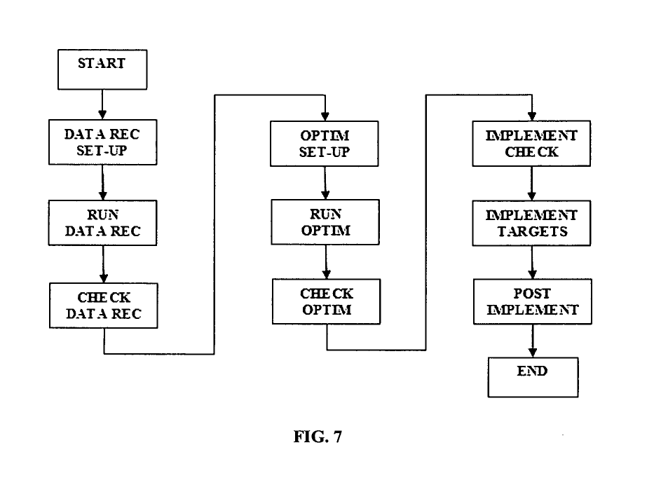

FIG. 7 illustrates the method in more detail. In FIG. 7, each square indicates another action in the process for using an H₂ system RTO as described herein.

First, is the “Start” step. The H₂ system RTO is activated and opens its associated model database in preparation for running. The H₂ system RTO can be invoked either automatically on a regular periodic basis (e.g., every thirty minutes) by a process control system or on demand by a refinery operator.

Second, is the “Data Rec Set-up” step. Here, the H₂ system RTO is set up for data reconciliation. Process operating data and status flags are imported into the flow sheet, and the H₂ system RTO processes any logic necessary to correctly configure the model. The operating data is as previously described. Typically, this operating data is downloaded automatically from a process control system and is based on actual analyzer information from inside the refinery.

Simultaneously, at this point, any economic data relevant to solving the optimization objective function is downloaded. This economic data is as previously described. Typically, this data is pulled from a process control system or plant data historian and is based on data created and updated by the refinery operator on a periodic basis. Economic data can also be loaded directly using a user interface.

Third, is the “Run Data Rec” step. The model, now properly configured for data reconciliation, is run in data reconciliation mode. The result is either “Successful,” “Invalid,” or “Fails.”

Fourth, is the “Check Data Rec” step. The final value or “best fit” for the data reconciliation objective function is checked. If the final value is over a threshold value, the run is either re-solved in an attempt to improve the fit or the sequence is abandoned. Flow sheet values are also updated to reflect the new solution.

Fifth, is the “Optim Set-up” step. Here, process control system constraint limits and status are read in. Further, any necessary logic is processed to configure the flow sheet for the optimization run. These constraints are as previously described. Typically, constraints are pulled from a process control system or plant data historian where they have been previously entered by the refinery operator to define the allowable operating window of the plant. However, some of the constraints can be loaded by the plant operator using the application interface.

Sixth, is the “Run Optim” step. The model is run to solve the objective function for the hydrogen system while meeting consumption requirements given operating constraints. The result is either “Successful,” “Invalid” or “Fails.” If, “Successful,” then the output is a solution consisting of optimal or near optimal steady state operating targets.

Seventh, is the “Check Optim” step. Here, the optimization solution is checked. This can include a custom check to make sure that the solution actually improves the objective function. Macros to produce reports should also be run at the conclusion of these checks.

Eighth, is the “Implement Check” step. Process control system limits and status are read in again, to ensure that any changes therein do not affect the optimization solution.

Ninth, is the “Implement Targets” step. If all is successful up to this point, the optimal targets of the optimization solution are sent to a process control system or to a plant operator computer. The solution of operating targets may be automatically communicated to and implemented by a process control system. Alternatively, the solution of operating targets may be automatically sent to a plant operator computer and implemented on command by the plant operator, upon review and approval of the operating targets, using a process control system.

Tenth, is the “Post Implement Step.” Any clean-up or status flag setting necessary for as a result of successful completion is performed at this point. For instance, a flag might be sent to the plant operator that implementation was successful.

Eleventh, and finally, is the “End” step. The sequence is finished and the model database is closed.

In one embodiment of the method, all the steps described above are conducted automatically, on-line, in communication and cooperation with at least one process control system, preferably a model based multi-variable process control system such as a DMC. In this embodiment, the operating data, any economic data and the operating constraints for the problem to be solved are automatically downloaded from a process control system and/or other plant data historian. The application is then run automatically and the results are automatically sent to and implemented by a process control system.

In another embodiment of the method, all of the steps described above except the implementation are conducted automatically, on-line, in communication and cooperation with a process control system, preferably a model based multi-variable control system such as a DMC. In this embodiment, the operating data, any economic data and the operating constraints for the optimization problem to be solved are automatically downloaded from at least one process control system and/or other plant data historian. The application is then run automatically and the results are automatically sent to a plant operator computer. Then a refinery operator reviews and approves the results and implements the results using a process control system.

In another embodiment of the method, at least one step, in addition to the implementation step, is conducted manually off-line. In this embodiment, the operating data, any economic data and the operating constraints for the optimization problem to be solved can be downloaded automatically from a process control system and/or other plant data historian. Alternatively, some or all of the data may be entered directly by the user at the time of the run using an application user interface based on laboratory data or a hypothetical “what if” scenario. The application is then run and results may be implemented manually, upon review and approval of the refinery operator, or automatically, using the process control system.

### Refinery

Finally, another embodiment of the invention is a refinery, preferably an oil refinery. The refinery comprises at least three components.

The first component is a hydrogen system. Preferably, the hydrogen system is any one of the hydrogen system embodiments, or combinations thereof, previously described and, therefore, comprises one or more, and preferably multiple, supply sources that provide hydrogen at individual rates, purities, pressures and costs, multiple consumption sites that consume hydrogen at individual rates, purities and pressures and an interconnecting hydrogen distribution network.

The second component is at least one process control system that controls the hydrogen system. Preferably, a model based, multi-variable process controller such as a DMC is employed.

The third component is a H₂ system RTO application for optimizing the supply and allocation and, thereby, consumption, of hydrogen gas in the hydrogen system. Preferably, the RTO computer application is any embodiment of the RTO computer application described above or any combination thereof. Accordingly, the application preferably comprises linked non-linear kinetic models that characterize the movement and consumption (and in some cases the supply if, for example, an H₂ plant exists) of hydrogen gas in the hydrogen system. Preferably, the models in the application also track the movement and consumption of associated light gases. More particularly, the models for the hydrogen consumption units represent light gases as discrete components and lump heavier materials into key performance characteristics, including olefinic compounds, aromatic compounds, organic nitrogen and organic sulfur, that are chosen such that the models will predict the correct shift in light gases when an operational change is introduced. Typically, the models would also track the disposal of unused or expended hydrogen gas and associated light gases into a fuel gas system that powers the refinery.

The H₂ system RTO loads current operating data and uses said operating data to populate and calibrate the models. The H₂ system RTO also loads operating constraints for the hydrogen system. The H₂ system RTO then manipulates, in an iterative manner, model variables to determine feasible solutions of operating targets for the hydrogen system that meet operating constraints. The H₂ system RTO then outputs a recommended solution of operating targets to move the operation of the hydrogen system toward a performance related objective function. Finally, the H₂ system RTO communicates the recommended solution of operating targets to the process control system. Preferably, the recommended solution is the optimal solution to the objective function.

Again, the objective function may be related to any performance parameter for the hydrogen system. For instance, the objective function may be the minimization of hydrogen gas bleed to fuel gas or, conversely, the maximization of hydrogen gas fed to high value consumption units.

In one embodiment the objective function is an economic objective function. For example, the objective function may be the minimization of cost. In such case, the method will further comprise the steps of loading economic data for calculating the costs of hydrogen supply and distribution (as previously described) into the application of hydrogen supply and distribution and calculating said costs for each feasible solution. Alternatively, the objective function may be the maximization of profit. In such case, the method will further comprise the steps of loading economic data for calculating values of products made by the consumption sites (as previously described) and costs for hydrogen supply and distribution (as previously described) and calculating profit as a difference between the sum of said product values and the sum of said hydrogen supply and distribution costs for each feasible solution.

Accordingly, in a preferred embodiment, the refinery comprises at least three components. The first component is a hydrogen system that includes one or more supply sources that provide hydrogen at individual rates, purities, pressures and costs, multiple consumption sites that consume hydrogen at individual rates, purities and pressures, and an interconnecting hydrogen distribution network. The second component is at least one process control system that controls the hydrogen system. The third component is an optimizer comprising a computer loaded with a real time optimization computer application. The application optimizes the supply and allocation of hydrogen gas in the hydrogen system and comprises linked, non-linear, kinetic models for the movement and consumption of hydrogen gas in the hydrogen system. The application (a) loads current refinery operating data and uses said operating data to populate and calibrate the models, (b) loads operating constraints for the hydrogen system, (c) manipulates, in an iterative manner, model variables to determine feasible solutions of operating targets for the hydrogen system that meet operating constraints, (d) outputs a recommended solution of operating targets to move the operation of the hydrogen system toward a performance related objective function and (e) communicates the recommended solution of operating targets to the process control system.

In each case, the application runs automatically on a regular basis. More preferably, the H₂ system RTO is run at least once and hour and, ideally, every 15 to 30 minutes. However, the H₂ system RTO can be run as fast as every 1 to 10 minutes.

In each case, in one embodiment, the computer is in on-line communication with the process control system and the recommended solution of operating targets, comprising one or more control component adjustments outputted by the computer, are automatically communicated to and implemented by the process controller. Alternatively, the recommended solution of operating targets may be implemented on command by a plant operator, using a process control system, upon review and approval of the targets.

The refinery is preferably a fully on-line operation, meaning that the optimization and implementation are performed automatically in communication with a process control system. Accordingly, in the preferred embodiment, the H₂ system RTO performs each of the following functions automatically: (i) populates the model with actual refinery data automatically pulled from a process control system and loads any economic data relevant to solving the objective function pulled from a process control system and/or other plant data historian; (ii) calibrates the models to the plant data; (iii) loads process constraints pulled from a process control system and/or other plant data historian, (iv) solves for optimal targets for the hydrogen system that achieve the objective function while meeting consumption needs and operating constraints; and (iv) implements the solution using a process control system.

### CONCLUSION

In summation, some embodiments of the invention are reiterated below.

A first embodiment is an apparatus comprising a real time optimization computer application stored on a program storage device readable by a computer. The application optimizes the supply and allocation of hydrogen gas in a hydrogen system of a refinery that comprises one or more supply sources that provide hydrogen at individual rates, purities, pressures and costs, multiple consumption sites that consume hydrogen at individual rates, purities and pressures and an interconnecting hydrogen distribution network. The application comprises linked, non-linear, kinetic models for the movement and consumption hydrogen gas in the hydrogen system. The application loads current refinery operating data and uses said operating data to populate and calibrate the models, loads operating constraints for the hydrogen system, manipulates, in an iterative manner, model variables to determine feasible solutions of operating targets for the hydrogen system that meet operating constraints and outputs a recommended solution of operating targets to move the operation of the hydrogen system toward a performance related objective function.

Numerous variations of this first apparatus embodiment exist. In a first variation, the recommended solution of operating targets is the optimal solution to the objective function. In a second variation, the objective function is an economic objective function. In a third variation, the objective function is minimization of cost and the application loads economic data for calculating costs for hydrogen supply and distribution and uses said economic data to calculate said costs for each feasible solution. In a fourth variation, the objective function is maximization of profit and the application loads economic data for calculating values for products made by the hydrogen consumption sites and costs for hydrogen supply and distribution and uses said economic data to calculate profit as a difference between the sum of said product values and the sum of said hydrogen supply and distribution costs for each feasible solution. In a fifth variation, the models in the application additionally comprise one or more linked, non-linear kinetic models for a hydrogen gas production plant or other hydrogen supply source. In a sixth variation, the models in the application track the movement and consumption of hydrogen gas and associated light gases. In a seventh variation, the models in the application for the hydrogen consumption units represent light gases as discrete components and lump heavier materials into key performance characteristics, including olefinic compounds, aromatic compounds, organic nitrogen and organic sulfur, that are chosen such that the models will predict the correct shift in light gases when an operational change is introduced. In an eighth variation, the models in the application track the disposal of unused or expended hydrogen gas and associated light gases into a fuel gas system that powers the refinery. In a ninth variation, the application is integrated with, or in communication with, at least one process control system, and runs automatically on a regular periodic basis. In a tenth variation, the recommended solution of operating targets is automatically communicated to and implemented by the process control system. In an eleventh variation, penalties are assigned to feasible solutions that fail to comply with specified variable limits, and the amount of each penalty depends on the variable limit violated and the degree of the violation. In a twelfth variation, the constraints for some variables are adjusted based on a prediction of transient response. In a thirteenth variation, the refinery is an oil refinery and the supply sources comprise multiple sources selected from the group consisting of purchased hydrogen, on-site hydrogen manufacturing plants, hydrogen rich off gases recycled from the hydrogen consumption sites, hydrogen rich off gases produced by a catalytic reformer and hydrogen routed from an associated petrochemical plant. In a fourteenth variation, the refinery is an oil refinery and the consumption sites comprise multiple hydroprocessing units selected from the group consisting of hydrotreaters and hydrocrackers. In a fifteenth variation, the interconnecting hydrogen distribution network comprises multiple control components to alter the flow, rate, purity and/or pressure of hydrogen selected from the group consisting of valves, separation membranes, scrubbers, pressure swing absorbers and compressors. In a sixteenth variation, the operating targets include flow controller settings for distributing H₂ across the network to consumers, pressure controller settings to move H₂ distribution across specific lines in the H₂ network, flow meter settings for the purchase of high and low pressure H₂ from third parties, temperature controller settings, valve position settings, compressor speeds and stream purities. In a seventeenth variation, the refinery is an oil refinery that comprises multiple supply sources and the application loads current refinery operating data and uses said operating data to populate and calibrate the models, loads economic data for calculating costs for hydrogen supply and distribution, loads operating constraints for the hydrogen system, manipulates, in an iterative manner, model variables to determine feasible solutions of operating targets for the hydrogen system that meet operating constraints and, for each feasible solution, calculates the costs for hydrogen supply and distribution and outputs the optimal solution of operating targets to minimize cost. In an eighteenth variation, the refinery is an oil refinery that comprises multiple supply sources and the application loads current refinery operating data and uses said operating data to populate and calibrate the models, loads economic data for calculating values for products made by hydrogen consumers in the hydrogen system and costs for hydrogen supply and distribution in the hydrogen system; loads operating constraints for the hydrogen system, manipulates, in an iterative manner, model variables to determine feasible solutions of operating targets for the hydrogen system that meet operating constraints and, for each feasible solution, uses said economic data to calculate profit as a difference between the sum of said product values and the sum of said hydrogen supply and distribution costs, and outputs the optimal solution set of operating targets to maximize profit. Each of these variations may be utilized in the first embodiment either alone or in any combination.

A second embodiment is an apparatus comprising a computer loaded with a real time optimization computer application. The application is the same as the application described with regard to the apparatus of the first embodiment and may include any of the described variations thereto or any combination thereof.

A third embodiment is a method of controlling the supply and allocation of hydrogen gas in a hydrogen system of a refinery. The method comprises one or more supply sources that provide hydrogen at individual rates, purities, pressures and costs, multiple consumption sites that consume hydrogen at individual rates, purities and pressures and an interconnecting hydrogen distribution network. The method comprises at least six computer implemented steps. The first step is activating a real time optimization computer application that comprises linked non-linear kinetic models for the movement and consumption of hydrogen gas in the hydrogen system. The second step is loading current refinery operating data into the application and using said operating data to populate and calibrate the models. The third step is loading operating constraints into the application. The fourth step is manipulating, in an iterative manner, model variables to determine feasible solutions of operating targets for the hydrogen system that meet operating constraints. The fifth step is determining a recommended solution of operating targets to move the operation of the hydrogen system toward a performance related objective function. The sixth step is implementing the recommended solution of operating targets with at least one process control system to change the settings for one or more control components selected from valves, separation membranes, scrubbers, pressure swing absorbers and compressors.

Numerous variations of this third method embodiment exist. Among other things, the computer application may be the application described in the first embodiment and may include any of the described variations thereto or any combination thereof. In one variation, the cycle of method steps are run automatically on a regular periodic basis and the recommended operating targets are automatically communicated to a plant operator computer and, upon review and approval, implemented using the process control system. Alternatively, in another variation, the cycle of method steps are run automatically on a regular periodic basis and the recommended operating targets are automatically communicated to and implemented by the process control system.

A fourth embodiment is a method for operating in an oil refinery.

The oil refinery comprises (i) multiple H₂ consumption units that consume H₂ in order to produce refinery products, each H₂ consumption unit having one or more control components and (ii) an H₂ distribution network that distributes H₂ to the H₂ consumption units, the H₂ distribution network also having multiple control components. The method comprises at least eight steps. The first step is formulating a non-linear programming model that comprises an objective function and one or more constraints, wherein the objective function is for an economic parameter, wherein the quantity of refinery products produced by each H₂ consumption unit is represented as a function of the quantity of H₂ consumed by the H₂ consumption units as supplied by the H₂ distribution network and wherein the quantity of H₂ supplied by the H₂ distribution network is represented as a function comprising one or more of the flow rate, purity, temperature and pressure of the H₂ streams in the H₂ distribution network. The second step is receiving economic data comprising the monetary value of the refinery products produced at the H₂ consumption units. The third step is populating the non-linear programming model with the economic data. The fourth step is receiving refinery operating data comprising at least one reactor parameter that determines a reactor condition for the H₂ consumption units and at least one operating parameter that determines the flow rate, purity, temperature and/or pressure of H₂ streams in the H₂ distribution network. The fifth step is populating the non-linear programming model with the refinery operating data. The sixth step is obtaining a solution to the non-linear programming model. The seventh step is adjusting one or more control components of the H₂ distribution network and/or H₂ consumption units according to the solution obtained. The eighth step is periodically repeating steps one through seven.

Numerous variations of this fourth method embodiment exist. In a first variation, the objective function is either minimization of cost to supply and distribute H₂ or maximization of profit, wherein profit is calculated as the difference in value between the value of products produced by the H₂ consumption units and the cost to supply and distribute the H₂. In a second variation, at least one H₂ consumption unit is a hydrocracking unit that produces a plurality of light gases, and wherein the quantity of H₂ consumed by the hydrocracking unit is represented as a function comprising the quantity of H₂ consumed in generating each of the light gases. In a third variation, at least one H₂ consumption unit is a hydrotreating unit, and wherein the quantity of H₂ consumed by the hydrotreating unit is represented as a function comprising the quantity of H₂ consumed by the following processes: desulphurization, denitrogenation, saturation or hydrogenation of unsaturated non-aromatic compounds, and saturation or hydrogenation of aromatic compounds. In a third variation, the one or more constraints of the non-linear programming model includes one or more of the following constraints for each H₂ consumption unit: flow rate of gas feeds; refinery products and effluents; temperature of a reactor inlet, reactor outlet, hot separator, and cold separator; pressure of a reactor, hot separator, and cold separator; valve position of a control component; treat-gas ratio; reactor H₂ partial pressure; reactor effective isothermal temperature; flow velocity; equipment duties; stream qualities; and stream purities. In a fourth variation, the oil refinery further comprises one or more H₂ plants and the amount of H₂ produced at each H₂ plant is represented as a function comprising the kinetics of steam reforming, water-gas shift and methanation, (ii) the one or more constraints of the non-linear programming model includes one or more of the reactor operating temperature, H₂:carbon ratio of the feed, steam rate, H₂ product purity, and CO/CO₂ purity for each H₂ plant, (iii) the economic data further comprises the monetary cost of operating the one or more H₂ plants, (iv) the operating data further comprises at least one parameter that determines a reactor condition for an H₂ plant, and (v) the adjusting step may comprise adjusting a control component of an H₂ plant according to the solution obtained. In a fifth variation, the control components of the H₂ distribution network include one or more of the following: a valve, a separation membrane, a scrubber, a pressure swing absorber, and a compressor. In a sixth variation, the method further comprises recognizing when a constraint of the non-linear programming model has been violated and, in response, relaxing the constraint, and wherein the objective function further comprises a penalty function that is a cost value of the constraint violation. In a seventh variation, the method further comprises predicting a transient response to the adjusting step, and adjusting a constraint of the non-linear programming model according to the predicted transient response. In an eighth variation, the oil refinery further comprises one or more fuel gas furnaces having one or more control components; wherein the non-linear programming model further comprises a constraint for the fuel gas requirements of each fuel gas furnace; wherein the economic data further comprises the monetary value of the heat generated by each fuel gas furnace; wherein the refinery operating data further comprises the amount of light gases being supplied to the fuel gas furnace, or the amount of heat generated by each fuel gas furnace, or both; and wherein the method further comprises adjusting a control component of a fuel gas furnace according to the solution obtained. In a ninth variation, the light gases in the oil refinery are represented as discrete components and the heavier materials are lumped together into groups based on distillation ranges. Each of these variations may be utilized in the fourth embodiment either alone or in any combination.

A fifth embodiment is a refinery comprising at least three components. The first component is a hydrogen system that includes one or more supply sources that provide hydrogen at individual rates, purities, pressures and costs, multiple consumption sites that consume hydrogen at individual rates, purities and pressures, and an interconnecting hydrogen distribution network. The second component is at least one process control system that controls the hydrogen system. The third component is an optimizer comprising a computer loaded with a real time optimization computer application for optimizing the supply and allocation of hydrogen gas in the hydrogen system. The application comprises linked, non-linear, kinetic models for the movement and consumption of hydrogen gas in the hydrogen system. The application loads current refinery operating data and uses said operating data to populate and calibrate the models. The application also loads operating constraints for the hydrogen system. The application then manipulates, in an iterative manner, model variables to determine feasible solutions of operating targets for the hydrogen system that meet operating constraints. The application then outputs a recommended solution of operating targets to move the operation of the hydrogen system toward a performance related objective function. Finally, or simultaneously, the application then communicates the recommended solution of operating targets to the process control system.

Numerous variations of this fifth refinery embodiment exist. Among other things, the computer application may be the application described in the first apparatus embodiment and may include any of the described variations thereto or any combination thereof.

A sixth embodiment is an oil refinery. The oil refinery comprises multiple components. First, there are multiple H₂ consumption units that consume H₂ in producing refinery products, each H₂ consumption unit having one or more control components. Next there is an H₂ distribution network that distributes H₂ to the H₂ consumption units, the H₂ distribution network having multiple control components. There is also a process control system that controls the one or more control components of the H₂ consumption unit and the H₂ distribution network. In addition, there is a computer loaded with a non-linear modeling application. The modeling application comprises an objective function for an economic parameter and one or more constraints, wherein the quantity of refinery products produced by each H₂ consumption unit is represented as a function of the quantity of H₂ consumed by the H₂ consumption units and supplied by the H₂ distribution network, wherein the quantity of H₂ supplied by the H₂ distribution network is represented as a function of one or more of the quantity, flow rate, purity, composition, and pressure of the H₂ streams in the H₂ distribution network. The modeling application performs each the following steps: (a) receives economic data comprising the monetary value of refinery products produced at the H₂ consumption units; (b) populates a non-linear programming model with the economic data; (c) receives refinery operating data comprising one or more reactor parameters that determine a reactor condition for each H₂ consumption unit and one or more operating parameters that determine the quantity, flow rate, purity, composition, and/or pressure of H₂ streams in the H₂ distribution network; (d) populates the non-linear programming model with the refinery operating data; (e) obtains a solution to the non-linear programming model; and (f) outputs a recommended adjustment to one or more control components of the H₂ distribution network, the H₂ consumption unit, or both, according to the solution obtained.

Numerous variations of this fifth embodiment exist. Among other things, the computer application may be the application described in the first embodiment and may include any of the described variations thereto or any combination thereof. In one variation, the computer is in on-line communication with the process control system and the process control system automatically performs a control component adjustment according to the recommended adjustment outputted by the computer.

However, the present invention is not to be limited in scope to these specific embodiments or any other embodiments set forth herein. Additional embodiments and various modifications thereto will be readily apparent to those of ordinary skill in the art from the foregoing description and accompanying drawings. Further, although the present invention has been described herein in the context of a particular implementation in a particular environment for a particular purpose, those of ordinary skill in the art will recognize that its usefulness is not limited thereto and that the present invention can be beneficially implemented in any number of environments for any number of purposes. Accordingly, the claims set forth below should be construed in view of the full breath and spirit of the present invention as disclosed herein.

What is claimed is:

1. An apparatus comprising a real time optimization computer application stored on a program storage device readable by a computer, wherein the application optimizes the supply and allocation of hydrogen gas in a hydrogen system of a refinery that comprises one or more supply sources that provide hydrogen at individual rates, purities, pressures and costs, multiple consumption sites that consume hydrogen at individual rates, purities and pressures and an interconnecting hydrogen distribution network, where the application comprises linked, non-linear, kinetic models for the movement and consumption hydrogen gas in the hydrogen system and where the application (a) loads current refinery operating data and uses said operating data to populate and calibrate the models, (b) loads operating constraints for the hydrogen system, (c) manipulates, in an iterative manner, model variables to determine feasible solutions of operating targets for the hydrogen system that meet operating constraints and (d) outputs a recommended solution of operating targets to move the operation of the hydrogen system toward a performance related objective function.

2. The apparatus of claim 1 where the recommended solution of operating targets is the optimal solution to the objective function.

3. The apparatus of claim 1 where the objective function is an economic objective function.

4. The apparatus of claim 1 where the application loads economic data for calculating costs for hydrogen supply and distribution, where the application uses said economic data to calculate said costs for each feasible solution and where the objective function is minimization of cost.

5. The apparatus of claim 1 where the application loads economic data for calculating values for products made by the hydrogen consumption sites and costs for hydrogen supply and distribution, where the application uses said economic data to calculate profit as a difference between the sum of said product values and the sum of said hydrogen supply and distribution costs for each feasible solution and where the objective function is maximization of profit.

6. The apparatus of claim 1 additionally comprising one or more linked, non-linear kinetic models for a hydrogen gas production plant or other hydrogen supply source.

7. The apparatus of claim 1 where the models track the movement and consumption of hydrogen gas and associated light gases.

8. The apparatus of claim 1 where the models for the hydrogen consumption units represent light gases as discrete components and lump heavier materials into key performance characteristics, including olefinic compounds, aromatic compounds, organic nitrogen and organic sulfur, that are chosen such that the models will predict the correct shift in light gases when an operational change is introduced.

9. The apparatus of claim 1 where the models track the disposal of unused or expended hydrogen gas and associated light gases into a fuel gas system that powers the refinery.

10. The apparatus of claim 1 where the application is integrated with, or in communication with, at least one process control system, and runs automatically on a regular periodic basis.

11. The apparatus of claim 1 where the recommended solution of operating targets is automatically communicated to and implemented by the process control system.

12. The apparatus of claim 1 where penalties are assigned to feasible solutions that fail to comply with specified variable limits, and where the amount of each penalty depends on the variable limit violated and the degree of the violation.

13. The apparatus of claim 1 where constraints for some variables are adjusted based on a prediction of transient response.

14. The apparatus of claim 1 where the refinery is an oil refinery and the supply sources comprise multiple sources selected from the group consisting of purchased hydrogen, on-site hydrogen manufacturing plants, hydrogen rich off gases recycled from the hydrogen consumption sites, hydrogen rich off gases produced by a catalytic reformer and hydrogen routed from an associated petrochemical plant.

15. The apparatus of claim 1 where the refinery is an oil refinery and the consumption sites comprise multiple hydroprocessing units selected from the group consisting of hydrotreaters and hydrocrackers.

16. The apparatus of claim 1 where the interconnecting hydrogen distribution network comprises multiple control components to alter the flow, rate, purity and/or pressure of hydrogen selected from the group consisting of valves, separation membranes, scrubbers, pressure swing absorbers and compressors.

17. The apparatus of claim 1 where said operating targets include flow controller settings for distributing H₂ across the network to consumers, pressure controller settings to move H₂ distribution across specific lines in the H₂ network, flow meter settings for the purchase of high and low pressure H₂ from third parties, temperature controller settings, valve position settings, compressor speeds and stream purities.

18. An apparatus or claim 1 where the refinery is an oil refinery that comprises multiple supply sources and where the application (a) loads current refinery operating data and uses said operating data to populate and calibrate the models, (b) loads economic data for calculating costs for hydrogen supply and distribution, (c) loads operating constraints for the hydrogen system, (d) manipulates, in an iterative manner, model variables to determine feasible solutions of operating targets for the hydrogen system that meet operating constraints and, for each feasible solution, calculates the costs for hydrogen supply and distribution and (e) outputs the optimal solution of operating targets to minimize cost.

19. The apparatus of claim 1 where the refinery is an oil refinery that comprises multiple supply sources and where the application (a) loads current refinery operating data and uses said operating data to populate and calibrate the models, (b) loads economic data for calculating values for products made by hydrogen consumers in the hydrogen system and costs for hydrogen supply and distribution in the hydrogen system; (c) loads operating constraints for the hydrogen system, (d) manipulates, in an iterative manner, model variables to determine feasible solutions of operating targets for the hydrogen system that meet operating constraints and, for each feasible solution, uses said economic data to calculate profit as a difference between the sum of said product values and the sum of said hydrogen supply and distribution costs, and (e) outputs the optimal solution set of operating targets to maximize profit.

20. An apparatus comprising a computer loaded with a real time optimization computer application, wherein the application optimizes the supply and allocation of hydrogen gas in a hydrogen system of a refinery that comprises one or more supply sources that provide hydrogen at individual rates, purities, pressures and costs, multiple consumption sites that consume hydrogen at individual rates, purities and pressures and an interconnecting hydrogen distribution network, where the application comprises linked, non-linear, kinetic models for the movement and consumption hydrogen gas in the hydrogen system and where the application (a) loads current refinery operating data and uses said operating data to populate and calibrate the models, (b) loads operating constraints for the hydrogen system, (c) manipulates, in an iterative manner, model variables to determine feasible solutions of operating targets for the hydrogen system that meet operating constraints and (d) outputs a recommended solution of operating targets to move the operation of the hydrogen system toward a performance related objective function.

21. A method of controlling the supply and allocation of hydrogen gas in a hydrogen system of a refinery that comprises one or more supply sources that provide hydrogen at individual rates, purities, pressures and costs, multiple consumption sites that consume hydrogen at individual rates, purities and pressures and an interconnecting hydrogen distribution network, comprising the following computer implemented steps:
(i) activating a real time optimization computer application that comprises linked non-linear kinetic models for the movement and consumption of hydrogen gas in the hydrogen system;
(ii) loading current refinery operating data into the application and using said operating data to populate and calibrate the models;
(iii) loading operating constraints into the application;
(iv) manipulating, in an iterative manner, model variables to determine feasible solutions of operating targets for the hydrogen system that meet operating constraints;
(v) determining a recommended solution of operating targets to move the operation of the hydrogen system toward a performance related objective function; and
(vi) implementing the recommended solution of operating targets with at least one process control system to change the settings for one or more control components selected from valves, separation membranes, scrubbers, pressure swing absorbers and compressors.

22. The method of claim 21 where the recommended solution of operating targets is the optimal solution to the objective function.

23. The method of claim 21 where the objective function is an economic objective function.

24. The method of claim 21 where the objective function is minimization of cost and further comprising the step of loading economic data into the application for calculating the costs for hydrogen supply and distribution and the step of calculating said costs for each feasible solution.

25. The method of claim 21 where the objective function is maximization of profit and further comprising the step of loading economic data into the application for calculating values for products made by the consumption sites and costs for hydrogen supply and distribution and the step of calculating profit as a difference between the sum of said product values and the sum of said hydrogen supply and distribution costs for each feasible solution.

26. The method of claim 21 where the models for the hydrogen consumption units represent light gases as discrete components and lump heavier materials into key performance characteristics, including olefinic compounds, aromatic compounds, organic nitrogen and organic sulfur, that are chosen such that the models will predict the correct shift in light gases when an operational change is introduced.

27. The method of claim 21, where the cycle of method steps are run automatically on a regular periodic basis and the recommended operating targets are automatically communicated to a plant operator computer and, upon review and approval, implemented using the process control system.

28. The method of claim 21 where the cycle of method steps are run automatically on a regular periodic basis and the recommended operating targets are automatically communicated to and implemented by the process control system.

29. A method for operating in an oil refinery, where the oil refinery comprises (i) multiple H₂ consumption units that consume H₂ in order to produce refinery products, each H₂ consumption unit having one or more control components and (ii) an H₂ distribution network that distributes H₂ to the H₂ consumption units, the H₂ distribution network also having multiple control components, wherein the method comprises:
(a) formulating a non-linear programming model that comprises an objective function and one or more constraints, wherein the objective function is for an economic parameter, wherein the quantity of refinery products produced by each H₂ consumption unit is represented as a function of the quantity of H₂ consumed by the H₂ consumption units as supplied by the H₂ distribution network and wherein the quantity of H₂ supplied by the H₂ distribution network is represented as a function comprising one or more of the flow rate, purity, temperature and pressure of the H₂ streams in the H₂ distribution network;
(b) receiving economic data comprising the monetary value of the refinery products produced at the H₂ consumption units;
(c) populating the non-linear programming model with the economic data;
(d) receiving refinery operating data comprising at least one reactor parameter that determines a reactor condition for the H₂ consumption units and at least one operating parameter that determines the flow rate, purity, temperature and/or pressure of H₂ streams in the H₂ distribution network;
(e) populating the non-linear programming model with the refinery operating data;
(f) obtaining a solution to the non-linear programming model;
(g) adjusting one or more control components of the H₂ distribution network and/or H₂ consumption units according to the solution obtained; and
(h) periodically repeating steps (a)-(g).

30. The method of claim 29, wherein the objective function is either minimization of cost to supply and distribute H₂ or maximization of profit, wherein profit is calculated as the difference in value between the value of products produced by the H₂ consumption units and the cost to supply and distribute the H₂.

31. The method of claim 29, wherein at least one H₂ consumption unit is a hydrocracking unit that produces a plurality of light gases, and wherein the quantity of H₂ consumed by the hydrocracking unit is represented as a function comprising the quantity of H₂ consumed in generating each of the light gases.

32. The method of claim 29, wherein at least one H₂ consumption unit is a hydrotreating unit, and wherein the quantity of H₂ consumed by the hydrotreating unit is represented as a function comprising the quantity of H₂ consumed by the following processes: desulphurization, denitrogenation, saturation or hydrogenation of unsaturated non-aromatic compounds, and saturation or hydrogenation of aromatic compounds.

33. The method of claim 29, wherein the one or more constraints of the non-linear programming model includes one or more of the following constraints for each H₂ consumption unit: flow rate of gas feeds; refinery products and effluents; temperature of a reactor inlet, reactor outlet, hot separator, and cold separator; pressure of a reactor, hot separator, and cold separator; valve position of a control component; treat-gas ratio; reactor H₂ partial pressure; reactor effective isothermal temperature; flow velocity;
equipment duties; stream qualities; and stream purities.

34. The method of claim 29, wherein (i) the oil refinery further comprises one or more H₂ plants and the amount of H₂ produced at each H₂ plant is represented as a function comprising the kinetics of steam reforming, water-gas shift and methanation, (ii) the one or more constraints of the non-linear programming model includes one or more of the reactor operating temperature, H₂:carbon ratio of the feed, steam rate, H₂ product purity, and CO/CO₂ purity for each H₂ plant, (iii) the economic data further comprises the monetary cost of operating the one or more H₂ plants, (iv) the operating data further comprises at least one parameter that determines a reactor condition for an H₂ plant, and (v) the adjusting step may comprise adjusting a control component of an H₂ plant according to the solution obtained.

35. The method of claim 29, wherein the control components of the H₂ distribution network include one or more of the following: a valve, a separation membrane, a scrubber, a pressure swing absorber, and a compressor.

36. The method of claim 29, further comprising recognizing when a constraint of the non-linear programming model has been violated and, in response, relaxing the constraint, and wherein the objective function further comprises a penalty function that is a cost value of the constraint violation.

37. The method of claim 29, further comprising predicting a transient response to the adjusting step (g), and adjusting a constraint of the non-linear programming model according to the predicted transient response.

38. The method of claim 29, wherein the oil refinery further comprises one or more fuel gas furnaces having one or more control components; wherein the non-linear programming model further comprises a constraint for the fuel gas requirements of each fuel gas furnace; wherein the economic data further comprises the monetary value of the heat generated by each fuel gas furnace; wherein the refinery operating data further comprises the amount of light gases being supplied to the fuel gas furnace, or the amount of heat generated by each fuel gas furnace, or both; and wherein the method further comprises adjusting a control component of a fuel gas furnace according to the solution obtained.

39. The method of claim 29, wherein the light gases in the oil refinery are represented as discrete components and the heavier materials are lumped together into groups based on distillation ranges.

40. A refinery comprising the following components:
a hydrogen system that includes one or more supply sources that provide hydrogen at individual rates, purities, pressures and costs, multiple consumption sites that consume hydrogen at individual rates, purities and pressures, and an interconnecting hydrogen distribution network;
(ii) at least one process control system that controls the hydrogen system; and
(iii) an optimizer comprising a computer loaded with a real time optimization computer application for optimizing the supply and allocation of hydrogen gas in the hydrogen system, where the application comprises linked, non-linear, kinetic models for the movement and consumption of hydrogen gas in the hydrogen system and where the application (a) loads current refinery operating data and uses said operating data to populate and calibrate the models, (b) loads operating constraints for the hydrogen system, (c) manipulates, in an iterative manner, model variables to determine feasible solutions of operating targets for the hydrogen system that meet operating constraints, (d) outputs a recommended solution of operating targets to move the operation of the hydrogen system toward a performance related objective function and (e) communicates the recommended solution of operating targets to the process control system.

41. The refinery of claim 40 where the application output is the optimal solution to the objective function.

42. The refinery of claim 41 where the application objective function is an economic objective function.

43. The refinery of claim 42 where the application loads economic data for calculating costs for hydrogen supply and distribution, where the application uses said economic data to calculate said costs for each feasible solution and where the objective function is minimization of cost.

44. The refinery of claim 43 where the application loads economic data for calculating values for products made by the hydrogen consumption sites and costs for hydrogen supply and distribution, where the application uses said economic data to calculate profit as a difference between the sum of said product values and the sum of said hydrogen supply and distribution costs for each feasible solution and where the objective function is maximization of profit.

45. The refinery of claim 44 where the application additionally comprises one or more linked, non-linear kinetic models for a hydrogen gas production plant or other hydrogen supply source.

46. The refinery of claim 45 where the models for the hydrogen consumption units represent light gases as discrete components and lump heavier materials into key performance characteristics, including olefinic compounds, aromatic compounds, organic nitrogen and organic sulfur, that are chosen such that the models will predict the correct shift in light gases when an operational change is introduced.

47. The refinery of claim 48 where the application runs automatically on a regular periodic basis.

48. The refinery of claim 47 where the recommended solution of operating targets is automatically communicated to and implemented by the process control system.

49. An oil refinery comprising:
(i) multiple H₂ consumption units that consume H₂ in producing refinery products, each H₂ consumption unit having one or more control components;
(ii) an H₂ distribution network that distributes H₂ to the H₂ consumption units, the H₂ distribution network having multiple control components;
(iii) a process control system that controls the one or more control components of the H₂ consumption unit and the H₂ distribution network; and
(iv) a computer loaded with a non-linear modeling application, wherein the modeling application comprises an objective function for an economic parameter and one or more constraints, wherein the quantity of refinery products produced by each H₂ consumption unit is represented as a function of the quantity of H₂ consumed by the H₂ consumption units and supplied by the H₂ distribution network, wherein the quantity of H₂ supplied by the H₂ distribution network is represented as a function of one or more of the flow rate, purity, temperature and pressure of the H₂ streams in the H₂ distribution network and wherein the modeling application performs each the following steps—
(a) receives economic data comprising the monetary value of refinery products produced at the H₂ consumption units,
(b) populates a non-linear programming model with the economic data,
(c) receives refinery operating data comprising one or more reactor parameters that determine a reactor condition for each H₂ consumption unit and one or more operating parameters that determine the flow rate, purity, temperature and/or pressure of H₂ streams in the H₂ distribution network,
(d) populates the non-linear programming model with the refinery operating data,
(e) obtains a solution to the non-linear programming model, and
(1) outputs a recommended adjustment to one or more control components of the H₂ distribution network, the H₂ consumption unit, or both, according to the solution obtained.

50. The oil refinery of claim 49, wherein the computer is in on-line communication with the process control system, and wherein the process control system automatically performs a control component adjustment according to the recommended adjustment outputted by the computer.
